(19) United States
(12) Patent Application Publication
(10) Pub. No.: US 2025/0019503 A1
(43) Pub. Date: Jan. 16, 2025

(54) METAL COMPLEXED CYANURATE GERMICIDAL ADDITIVE FOR POLYMER COMPOSITIONS

(71) Applicant: SABIC Global Technologies B.V., Bergen op Zoom (NL)

(72) Inventors: Tayirjan Taylor Isimjan, Bengaluru (IN); Maher N. Aloufi, Bengaluru (IN); David West, Bengaluru (IN); Dhanabalan Anantharaman, Bengaluru (IN); Toseef Ahmed, Bengaluru (IN)

(21) Appl. No.: 18/713,382

(22) PCT Filed: Jun. 7, 2023
(86) PCT No.: PCT/EP2023/065226

§ 371 Date: May 24, 2024

(30) Foreign Application Priority Data
Jun. 29, 2022 (EP) 22181846.1

(51) Int. Cl. C08J 3/20; A01N 25/10; A01N 43/66; A01N 59/20; A01P 1/00; C08J 5/18; C08K 5/00

(52) U.S. Cl. CPC C08J 3/203; A01N 25/10; A01N 43/66; A01N 59/20; A01P 1/00; C08J 5/18; C08K 5/0058; C08J 2323/06

(57) ABSTRACT

Polymeric compositions that include a polymer matrix and a germicidal additive dispersed in the polymer matrix are described. The germicidal additive includes a metal complexed cyanurate composition having a general formula of Aₓ[M_{y}(C₃O₃N₃Cl₂)_{z}], where A is a counterion, x, y, and z are each independently 1 to 6, and M is a transition metal.

### CROSS REFERENCE TO RELATED APPLICATIONS

This application is a National Stage Application under 35 U.S.C. § 371 and claims the benefit of International Application No. PCT/EP2023/065226, filed Jun. 7, 2023, which claims benefit to European Patent Application No. EP 22181846 filed Jun. 29, 2022, the contents of both of which are incorporated herein by reference in their respective entirety.

### BACKGROUND

### A. Field

The disclosure generally concerns a polymeric composition that includes a polymer matrix and a germicidal additive dispersed in the polymer matrix. The germicidal additive can include a metal complexed cyanurate composition. The metal can include transition metals. The transition metals can include copper (Cu), nickel (Ni), cadmium (Cd), silver (Ag), iron (Fe) an alloy thereof, or a combination thereof.

### B. Description of Related Art

Germicidal additives can include bioactive materials that can hinder the life or growth of microorganisms. Examples of microorganisms include bacteria, viruses, mold, fungi, and algae. Germicidal additives can be classified as bacteriostatic and bactericides according to the type of germicidal activities. Germicidal additives that can eradicate the growth of bacteria include bactericidal antimicrobial additives. In contrast, those that prevent bacteria growth include bacteriostatic antimicrobial additives.

Some conventional germicidal additives are based on inorganic metals such as silver, copper, and zinc, formulated into different forms such as concentrated powder, liquid suspension, or master batch pellets, depending on the boarding substance and manufacturing method. For example, U.S. Patent Application Publication No. 2010/0136073 to Preuss et al., describes the use of silver and silver supported on zeolites in plastics and coatings, U.S. Patent Application Publication No. 2013/0178474 to Unhoch et al., describes water treatment compositions that include copper, zinc, and aluminum sulfates and trichloroisocyanuric acid, and U.S. Patent Application Publication No. 2015/0313912 to Karandikar describes hydrogel compositions that include silver cyanurate.

Other antimicrobial materials can include oxidizing agents that are also highly effective against a wide range of microbes. Scheme I illustrates the four main types of oxidizing agents ((A) sodium hypochlorite, (B) sodium dichloroisocyanurate, (C) hydrogen peroxide, and (D) peracetic acid).

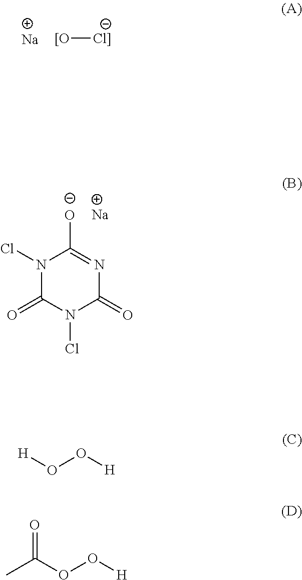

Hydrogen peroxide (C) and peracetic acid (D) can decompose to generate hydroxyl free radicals that can cleave or link to the proteins and lipid parts of the microbial. Sodium hypochlorite (A) and sodium dichloroisocyanurate (B) are known to slowly decompose to form water and reactive chloride anions which attack the microorganism. These compounds are used as disinfectants, sterilizer, bleaching agents, water treatment additives, and the like. However, these compounds can leach from materials, which can cause irritation to the skin and olfactory. They also suffer in that they can interact with other components in a polymer matrix causing unwanted byproducts. Further, these oxidizing additives suffer from having low thermal stability, further limiting their use. Therefore, these additives are commonly used in aqueous solutions. For example, U.S. Pat. No. 3,055,889 to Marek describes the use of metal complexed sodium dichloroisocyanurate as a bleaching agent or disinfectant in aqueous systems. In another example, U.S. Pat. No. 10,092,005 to Braun et al., describes using polymer pellets containing sodium dichloroisocyanurate for disinfecting water solutions. When the pellet is added to water, the sodium dichloroisocyanurate leaches from the polymer and dissolves in the aqueous solution.

While many antimicrobial and antiviral additives exist, there is a demand for a less expensive, non-toxic, readily available, user and environment-friendly additive for polymer applications.

### SUMMARY

A discovery has been made that provides a solution to at least one of the problems associated with germicidal additives in polymeric compositions. In one aspect, the discovery can include a germicidal additive dispersed in a polymeric composition. The germicidal additive can include a metal complexed cyanurate composition. The metal complexed cyanurate composition can also include an alkali metal, an alkaline earth metal or a combination thereof. An advantage of the germicidal additive of the present disclosure is that it is effective against bacteria, viruses, protozoa, algae, and fungi while dispersed in the polymer matrix. For example, the polymer composition containing the germicidal additive has an antibacterial efficacy of at least 80%, preferably 90%, more preferably 99% after 24 hours of incubation as measured by JISZ 2801:2010 method, when the bacteria are Staphylococcus aureus, Escherichia coli or a combination thereof. In another example, the polymer composition containing the germicidal additive is resistant to fungal growth after 4 weeks. Advantageously, the polymer compositions of the present disclosure have little to no chlorine odor and less leaching than conventional chlorine releasing agents (e.g., sodium dichlorocyanurate) incorporated into the same polymer absent the germicidal additive of the present disclosure. Still further, the use of the germicidal additives of the present disclosure with polymeric compositions can advantageously reduce leaching problems and/or can withstand higher temperatures (e.g., 150° C. to 300° C.) when processing the polymeric compositions into articles of manufacture. In some aspects, complexing the dichlorocyanurate with a transition metal (e.g., Cu) provides the advantage of modifying the water solubility properties of metal dichlorocyanurate complexes.

In one aspect of the present disclosure, polymeric compositions that include a polymer and a germicidal additive are described. A polymeric composition can include a germicidal additive dispersed in the polymer matrix. The germicidal additive can include a metal complexed cyanurate composition. Non-limiting examples of metals can include a transition metal. Non-limiting examples of transition metals can include Cu, Ni, Cd, Ag, Fe, an alloy thereof, or a combination thereof. Preferably, the metal complexed cyanurate composition can further include an alkali metal, an alkaline earth metal, aluminum, or a combination thereof. In some aspects, the metal complexed cyanurate composition has the general formula of Aₓ[M_{y}(C₃O₃N₃Cl₂)_{z}] where A is an optional counterion that includes an alkali metal, an alkaline earth metal, or aluminum (Al) or a combination thereof. x, y, and z can each independently be 1, 2, 3, 4, 5 and 6, and M can be a transition metal (e.g., Cu, Ni, Cd, Ag, V, Cr, Mn, Nb, Mo, Ru, Rh, Ir, Ta or Fe), an alloy thereof, or a combination thereof. In the metal complexed cyanurate composition, A is a counterion for electroneutrality, and the stoichiometry of A and depends on charge of the metal cyanurate (M_{y}(C₃O₃N₃Cl₂)_{z}). The metal complexed cyanurate composition can exist as M_{y}(C₃O₃N₃Cl₂)_{z}^{d-}, where d⁻ is the charge of the metal cyanurate ranging from 0 to 6. In some aspects, M can be Cu and the metal complexed cyanurate composition can include Aₓ[Cu(C₃O₃N₃Cl₂)₄], Cu(C₃O₃N₃Cl₂)₄]²⁻, or a mixture thereof, preferably Aₓ[Cu(C₃O₃N₃Cl₂)₄], more preferably Na₂[Cu(C₃O₃N₃Cl₂)₄. The germicidal additive can be a particle having a mean particle size of 1 to 30 microns, preferably 1 to 20 microns, more preferably 1 to 10 microns. The germicidal additive of the present disclosure can be effective against bacteria, viruses, protozoa, algae, and fungi. In a preferred aspect, the germicidal additive has an antibacterial efficacy of at least 80%, preferably 90%, more preferably 99% after 24 hours of incubation as measured by JISZ 2801:2010 method, where the bacteria comprise Staphylococcus aureus, Escherichia coli or a blend thereof.

The polymer matrix can include a thermoplastic polymer, a thermoset polymer, or a blend thereof. Non-limiting examples of the thermoplastic polymer includes polypropylene (PP), polyethylene (PE), polyethylene terephthalate (PET), polybutylene terephthalate (PBT), polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butyldiene styrene (ABS), poly(methyl methacrylate) (PMMA), blend of polycarbonate and polybutylene terephthalate (PBT), blend of polycarbonate-acrylonitrile butadiene styrene (ABS), blend of polyphenylene oxide and polystyrene, blend of polyphenylene oxide and polypropylene, elastomeric block co-polymers, blend of polycarbonate-polyethylene terephthalate (PET), polyamide, polystyrene (PS), engineered thermoplastic compositions, or blends or copolymers thereof, preferably polyethylene, polypropylene, copolymers thereof, or blends thereof.

The polymeric composition of the present disclosure can include at least 35 wt. % to 99.99 wt. % of the polymer matrix, 0.01 wt. % to 1 wt. % of the germicidal additive, and 0 wt. % to 65 wt. % of other additives, preferably at least 35 wt. % to 99.99 wt. % of the thermoplastic polymer matrix. In one aspect, the polymer composition can include 35 wt. % to 99.99 wt. % of the polymer matrix, 0.01 wt. % to 1 wt. % of Na₂[Cu(C₃O₃N₃Cl₂)₄], and 0 to 65 wt. % of other additives. Non-limiting examples of other additives include reinforcing fillers (e.g., short glass fibers, long glass fibers, talc, calcium carbonate, silica) antioxidants, heat stabilizers, nucleating agents, coupling agents and processing aids. Advantageously, the polymeric composition has a low, or is absent of, a chlorine odor (e.g., 0 to 5 milligrams of chloride in 1 L of water). For example, guidance to odor sensitivity can be found in various standardized methodologies, for example, in ISO 13301.2018. In some aspects, the polymeric composition is a pellet, a powder, or a molded part. In other aspects, the polymeric composition can be an extrusion molded article, an injection molded article, a compression molded article, a rotational molded article, a blow molded article, an injection blow molded article, a 3-D printed article, a thermoformed article, a foamed article, or a cast film. In other aspects of the disclosure, article of manufactures that include the polymeric composition of the present disclosure are described. Non-limiting examples of articles of manufacture can include an exterior and/or interior vehicle part, an exterior and/or interior train part, an exterior and/or interior airplane part, an exterior and/or interior building part, an electrical device part, an electronic device part, an industrial device part, medical packing film and/or component, a medical tray, a blister pack, a medical component container, a food packing film, or a food container. Preferably, the article of manufacture is a packing material (e.g., medical packing film or food packing film).

Methods of preparing the polymeric composition of the present disclosure are also described. A method can include combining (e.g., compounding) a germicidal additive that includes a metal complexed cyanurate composition with a polymer matrix at 150° C. to 300° C. to produce the polymeric composition of the present disclosure. The metal can include Cu, Ni, Cd, Ag, Fe, an alloy thereof, or a combination thereof. The metal complexed cyanurate composition can be produced by reacting a metal precursor with an aqueous solution of a cyanurate composition. In a preferred aspect, the cyanurate composition can be sodium dichloroisocyanurate.

Other embodiments of the disclosure are discussed throughout this application. Any embodiment discussed with respect to one aspect of the disclosure applies to other aspects of the disclosure as well and vice versa. Each embodiment described herein is understood to be embodiments of the disclosure that are applicable to other aspects of the disclosure. It is contemplated that any embodiment or aspect discussed herein can be combined with other embodiments or aspects discussed herein and/or implemented with respect to any method or composition of the disclosure, and vice versa. Furthermore, compositions of the disclosure can be used to achieve methods of the disclosure.

The following includes definitions of various terms and phrases used throughout this specification.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %”, or “mol. %” refers to a weight percentage of a component, a volume percentage of a component, or molar percentage of a component, respectively, based on the total weight, the total volume of material, or total moles, which includes the component. In a non-limiting example, 10 grams of component in 100 grams of the material is 10 wt. % of the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The polymeric compositions of the present disclosure can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the polymeric compositions of the present disclosure are their abilities to provide protection against microorganisms and/or viruses.

Other objects, features and advantages of the present disclosure will become apparent from the following figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present disclosure may become apparent to those skilled in the art with the benefit of the following detailed description and upon reference to the accompanying drawings.

FIG. 1 illustrated thermal gravimetric (TG) degradation studies of the inventive germicidal additive (CuDCC, top two curves) and a comparative additive (NaDCC, bottom two curves) in the presence of air and nitrogen.

FIG. 2 illustrates scanning electron microscopy (SEM) images and energy dispersive X-ray spectroscopy (EDX) mapping of a CuDCC-LLDPE composition of the present disclosure: (A) & (B) cross-section images, (C) EDX Na mapped 50 microns, (D) Cl-mapping at 50 microns, (E) N-mapping at 50 microns. SEM Instrumentation: Thermoscientific Quanta 200, EDX Instrumentation: EDAX Elect Super SDD with Team software.

FIG. 3 illustrates SEM images and EDX mapping of the NaDCC-LLDPE comparative sample: (A) & (B) cross-section images, (C) EDX Na mapped 50 um, (D) Cl-mapping at 50 um, (E) N-mapping at 50 μm.

FIG. 4 illustrates antibacterial results of 0.2 wt. % CuDCC-LLDPE composition of the present disclosure and 0.2 wt. % NaDCC-LLDPE composition of the present disclosure on S. aureus ATCC 6538P and E. coli ATCC8739.

FIG. 5 illustrates antiviral results of 1.0 wt. % and 5 wt. % of CuDCC-LLDPE compositions of the present disclosure on human Influenza A virus (H1N1). The test duration was six hours.

FIGS. 6A and 6B illustrate leaching results of 10 wt. % of CuDCC-LLDPE composition of the present disclosure and 10 wt. % NaDCC-LLDPE comparative sample in 40 mL water after 24 hours: FIG. 6A: Hypochlorite production in ppm; FIG. 6 B: Chloride production in ppm.

While the disclosure is susceptible to various modifications and alternative forms, specific embodiments thereof are shown by way of example in the drawings. The drawings may not be to scale.

### DETAILED DESCRIPTION

A discovery has been made that provides a solution to at least one of the problems associated with antimicrobial additives in polymeric compositions. In one aspect, the discovery can include a germicidal additive dispersed in a polymeric composition. The germicidal additive can include a transition metal (e.g., copper (Cu), nickel (Ni), cadmium (Cd), silver (Ag), iron (Fe)), or an alloy thereof, or a combination thereof complexed cyanurate composition. In addition, the germicidal additive can include an alkaline earth metal, an alkali metal, aluminum, or a combination thereof. The incorporation of the metal complexed cyanurate into the polymer composition imparts germicidal properties to the resulting composition. The compositions can help protect (e.g., prevent or reduce microbial growth) against infectious or deadly microorganisms (e.g., bacteria, protozoa, algae, and/or fungi). When the cyanurate is a dichlorocyanurate (DCC) complex, the polymer composition of the present disclosure can advantageously have a higher dichlorocyanurate content per molecule, a lower DCC releasing rate, dual active sites, and no or less odor as compared to the use of NaDCC in the same polymer matrix absent the metal complexed cyanurate of the present disclosure.

These and other non-limiting aspects of the present disclosure are discussed in further detail in the following sections.

### A. Polymeric Composition

The polymer composition of the present disclosure can include a polymer matrix, a germicidal additive dispersed in the polymer matrix, and optionally other additives. The polymeric composition contains at least 35 wt. % to 99.99 wt. % of the polymer matrix, 0.01 wt. % to 1 wt. % of the germicidal additive, and 0 wt. % to 65 wt. % of other additives. Advantageously, the polymer composition has a low, or is absent of, a chlorine odor. The polymeric composition can be in a pellet form, a powder, or a molded part. In some aspects, the polymeric composition is an extrusion molded article, an injection molded article, a compression molded article, a rotational molded article, a blow molded article, an injection blow molded article, a 3-D printed article, a thermoformed article, a foamed article, or a cast film. In some aspects, an article of manufacturing (e.g., packaging) includes the polymeric composition of the present disclosure. Non-limiting examples of an article of manufacture can include an exterior and/or interior vehicle part, an exterior and/or interior train part, an exterior and/or interior airplane part, an exterior and/or interior building part, an electrical device part, an electronic device part, an industrial device part, packaging, medical packing film and/or component, a medical tray, a blister pack, a medical component container, a food packing film, or a food container. The polymer composition, and thus, the article of manufacture, has an efficacy against bacteria, viruses, protozoa, algae, and/or fungi. In a preferred aspect, and due to the presence of the germicidal additive, an antibacterial (e.g., Staphylococcus aureus, Escherichia coli or a blend thereof) efficacy of at least 80%, preferably 90%, more preferably 99% after 24 hours of incubation as measured by JISZ 2801:2010 method can be realized for the polymeric compositions of the present disclosure.

### 1. Germicidal Additive

The germicidal additive can be a metal complexed cyanurate compound. The metal can be a transition metal. Non-limiting examples of transition metals include Columns 3-12 of the Periodic Table. Preferred examples of transition metals include, Cu, Ni, Cd, Ag, V, Cr, Mn, Nb, Mo, Ru, Rh, Ir, Ta or Fe an alloy thereof, or a combination thereof. In addition, the germicidal additive can include an alkaline earth metal, an alkali metal, or aluminum as a counterion. The cyanurate can be a derivative of cyanuric acid (1,3,5-triazinane-2,4,6-trione)cyanurate. For example, the cyanurate can be dichlorocyanurate (DCC) having the formula (C₃O₃N₃Cl₂)⁻ shown below as Structure I. The sodium salt of DCC is commercially available from Aldrich (USA), Loyal Chemical Products (China), Sichuan Institute of Fine Chemical (China) and the like.

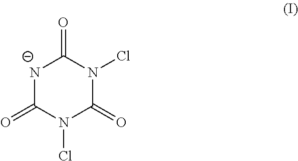 [SMILES: O=c1[n-]c(=O)n(Cl)c(=O)n1Cl]

The metal complexed cyanurate composition can have the general formula of Aₓ[M_{y}(C₃O₃N₃Cl₂)_{z}]. A is an optional counterion and can be an alkali metal, an alkaline earth metal, Al, or a combination thereof, and x, y, z, can each independently be 1 to 6. In some aspects, A is used to produce the metal complexed cyanurate composition and dissociates from the metal complexed cyanurate when contacted with a solvent (e.g., water). M_{y}(C₃O₃N₃Cl₂)_{z} can exist as a neutral or charged species depending on the stoichiometry of the transition metal and the cyanurate. For example, M_{y}(C₃O₃N₃Cl₂)_{z} can exist as M_{y}(C₃O₃N₃Cl₂)_{z}^{d-}, where d is from 0 to 6. Non-limiting examples of alkali metals include lithium (Li), sodium (Na), potassium (K), rubidium (Rb), or cesium (Cs). Non-limiting examples of alkaline earth metals include beryllium (Be), magnesium (Mg), calcium (Ca), strontium (Sr), or barium (Ba). M can be Cu, Ni, Cd, Ag, V, Cr, Mn, Nb, Mo, Ru, Rh, Ir, Ta or Fe, an alloy thereof, or a combination thereof. While non-limiting examples of some metal complexes are provided in the specification, it should be understood that all speciation of the transition metals are covered.

In one aspect of the present disclosure, non-limiting examples of a Cu complexed cyanurate composition include Aₓ[Cu_{y}(C₃O₃N₃Cl₂)_{z}], where x, y, and z are independently 1 to 6, Cu(C₃O₃N₃Cl₂)₄², or a mixture thereof, where A is an alkali metal, an alkaline earth metal, Al, or a combination thereof. Non-limiting examples of Cu complexed cyanurates with an alkali metal counter-ion can include Na₂[Cu(C₃O₃N₃Cl₂)₄], K₂[Cu(C₃O₃N₃Cl₂)₄], Li₂[Cu(C₃O₃N₃Cl₂)₄], Rb₂[Cu(C₃O₃N₃Cl₂)₄], or Cs₂[Cu(C₃O₃N₃Cl₂)₄]. In a preferred aspect, the metal complexed cyanurate can be Na₂[Cu(C₃O₃N₃Cl₂)₄]. Non-limiting example of the metal complexed cyanurate with an alkaline earth metal counterion can include Ca[Cu(C₃O₃N₃Cl₂)₄], Ba[Cu(C₃O₃N₃Cl₂)₄], Be[Cu(C₃O₃N₃Cl₂)₄], Mg[Cu(C₃O₃N₃Cl₂)₄], or Sr[Cu(C₃O₃N₃Cl₂)₄]. Non-limiting examples of Cu complexed cyanurates with Al can include Alₓ[Cu_{y}(C₃O₃N₃Cl₂)_{z}] alone or in combination with the alkali and alkaline earth metal counterion. Non-limiting examples, of a mixture of counterions can include Na₂[Cu(C₃O₃N₃Cl₂)₄] and Ca[Cu(C₃O₃N₃Cl₂)₄], Li₂[Cu(C₃O₃N₃Cl₂)₄] and Ca[Cu(C₃O₃N₃Cl₂)₄], Rb₂[Cu(C₃O₃N₃Cl₂)₄] and Ca[Cu(C₃O₃N₃Cl₂)₄], Cs₂[Cu(C₃O₃N₃Cl₂)₄] and Ca[Cu(C₃O₃N₃Cl₂)₄], Na₂[Cu(C₃O₃N₃Cl₂)₄] and Ba[Cu(C₃O₃N₃Cl₂)₄], Li₂[Cu(C₃O₃N₃Cl₂)₄] and Ba[Cu(C₃O₃N₃Cl₂)₄], K₂[Cu(C₃O₃N₃Cl₂)₄] and Ba[Cu(C₃O₃N₃Cl₂)₄], Rb₂[Cu(C₃O₃N₃Cl₂)₄] and Ba[Cu(C₃O₃N₃Cl₂)₄], Cs₂[Cu(C₃O₃N₃Cl₂)₄] and Ba[Cu(C₃O₃N₃Cl₂)₄], Na₂[Cu(C₃O₃N₃Cl₂)₄] and Be[Cu(C₃O₃N₃Cl₂)₄], K₂[Cu(C₃O₃N₃Cl₂)₄] and Be[Cu(C₃O₃N₃Cl₂)₄], Li₂[Cu(C₃O₃N₃Cl₂)₄] and Be[Cu(C₃O₃N₃Cl₂)₄], Rb₂[Cu(C₃O₃N₃Cl₂)₄] and Be[Cu(C₃O₃N₃Cl₂)₄], Cs₂[Cu(C₃O₃N₃Cl₂)₄] and Be[Cu(C₃O₃N₃Cl₂)₄], Na₂[Cu(C₃O₃N₃Cl₂)₄] and Mg[Cu(C₃O₃N₃Cl₂)₄], K₂[Cu(C₃O₃N₃Cl₂)₄] and Mg[Cu(C₃O₃N₃Cl₂)₄], Li₂[Cu(C₃O₃N₃Cl₂)₄] and Mg[Cu(C₃O₃N₃Cl₂)₄], Rb₂[Cu(C₃O₃N₃Cl₂)₄] and Mg[Cu(C₃O₃N₃Cl₂)₄], Cs₂[Cu(C₃O₃N₃Cl₂)₄] and Mg[Cu(C₃O₃N₃Cl₂)₄], Na₂[Cu(C₃O₃N₃Cl₂)₄] and Sr[Cu(C₃O₃N₃Cl₂)₄], K₂[Cu(C₃O₃N₃Cl₂)₄] and Sr[Cu(C₃O₃N₃Cl₂)₄], Li₂[Cu(C₃O₃N₃Cl₂)₄] and Sr[Cu(C₃O₃N₃Cl₂)₄], Rb₂[Cu(C₃O₃N₃Cl₂)₄] and Sr[Cu(C₃O₃N₃Cl₂)₄] or Cs₂[Cu(C₃O₃N₃Cl₂)₄] and Sr[Cu(C₃O₃N₃Cl₂)_{4].}

In another aspect, the metal complexed cyanurate can be a mixture of Na₂[Cu(C₃O₃N₃Cl₂)₄] and Cu(C₃O₃N₃Cl₂)₄², Li₂[Cu(C₃O₃N₃Cl₂)₄] and Cu(C₃O₃N₃Cl₂)₄², Rb₂[Cu(C₃O₃N₃Cl₂)₄] and Cu(C₃O₃N₃Cl₂)₄²⁻, Cs₂[Cu(C₃O₃N₃Cl₂)₄] and Cu(C₃O₃N₃Cl₂)₄², K₂[Cu(C₃O₃N₃Cl₂)₄] and Cu(C₃O₃N₃Cl₂)₄²⁻, Ba[Cu(C₃O₃N₃Cl₂)₄] and Cu(C₃O₃N₃Cl₂)₄², Ca[Cu(C₃O₃N₃Cl₂)₄] and Cu(C₃O₃N₃Cl₂)₄²⁻, Be[Cu(C₃O₃N₃Cl₂)₄] and Cu(C₃O₃N₃Cl₂)₄², Mg[Cu(C₃O₃N₃Cl₂)₄] and Cu(C₃O₃N₃Cl₂)₄²—, and Sr[Cu(C₃O₃N₃Cl₂)₄] and Cu(C₃O₃N₃Cl₂)₄².

In one aspect of the present disclosure, a non-limiting example of the metal complex is when M is Ni. The Ni metal complexed cyanurate composition can have the formula Aₓ[Ni_{y}(C₃O₃N₃Cl₂)_{z}], where x, y, and z are independently 1 to 6, Ni(C₃O₃N₃Cl₂)₄², or a mixture thereof, where A is an alkali metal, an alkaline earth metal, Al, or a combination thereof. Non-limiting examples, of the metal complexed cyanurate can have the formula with an alkali metal counterion can include Naₓ[Ni_{y}(C₃O₃N₃Cl₂)_{z}], Kₓ[Ni_{y}(C₃O₃N₃Cl₂)_{z}], Liₓ[Ni_{y}(C₃O₃N₃Cl₂)_{z}], Rbₓ[Ni_{y}(C₃O₃N₃Cl₂)_{z}], or Csₓ[Ni_{y}(C₃O₃N₃Cl₂)_{z}] where x, y and z are independently 1 to 6. Non-limiting examples of the metal complexed cyanurate with an alkaline earth metal counter can include Ca[Ni(C₃O₃N₃Cl₂)₄], Ba[Ni(C₃O₃N₃Cl₂)₄], Be[Ni(C₃O₃N₃Cl₂)₄], Mg[Ni(C₃O₃N₃Cl₂)₄], or Sr[Ni(C₃O₃N₃Cl₂)₄]. Non-limiting examples of Ni complexed cyanurates with Al can include Alₓ[Ni_{y}(C₃O₃N₃Cl₂)_{z}] alone or in combination with the described Ni complexed cyanurates. Non-limiting examples of the metal complexed cyanurate with a mixture counterions can include Naₓ[Ni_{y}(C₃O₃N₃Cl₂)_{z}] and Ca[Ni(C₃O₃N₃Cl₂)₄], Kₓ[Ni_{y}(C₃O₃N₃Cl₂)_{z}] and Ca[Ni(C₃O₃N₃Cl₂)₄], Liₓ[Ni_{y}(C₃O₃N₃Cl₂)_{z}] and Ca[Ni(C₃O₃N₃Cl₂)₄], Rbₓ[Ni_{y}(C₃O₃N₃Cl₂)_{z}] and Ca[Ni(C₃O₃N₃Cl₂)₄], Csₓ[Ni_{y}(C₃O₃N₃Cl₂)_{z}] and Ca[Ni(C₃O₃N₃Cl₂)₄], Naₓ[Ni_{y}(C₃O₃N₃Cl₂)_{z}] and Ba[Ni(C₃O₃N₃Cl₂)₄], Liₓ[Ni_{y}(C₃O₃N₃Cl₂)_{z}] and Ba[Ni(C₃O₃N₃Cl₂)₄], Kₓ[Ni_{y}(C₃O₃N₃Cl₂)_{z}] and Ba[Ni(C₃O₃N₃Cl₂)₄], Rbₓ[Ni_{y}(C₃O₃N₃Cl₂)_{z}] and Ba[Ni(C₃O₃N₃Cl₂)₄], Csₓ[Ni_{y}(C₃O₃N₃Cl₂)_{z}] and Ba[Ni(C₃O₃N₃Cl₂)₄], Naₓ[Ni_{y}(C₃O₃N₃Cl₂)_{z}] and Be[Ni(C₃O₃N₃Cl₂)₄], Kₓ[Ni_{y}(C₃O₃N₃Cl₂)_{z}] and Be[Ni(C₃O₃N₃Cl₂)₄], Liₓ[Ni_{y}(C₃O₃N₃Cl₂)_{z}] and Be[Ni(C₃O₃N₃Cl₂)₄], Rbₓ[Ni_{y}(C₃O₃N₃Cl₂)_{z}] and Be[Ni(C₃O₃N₃Cl₂)₄], Csₓ[Ni_{y}(C₃O₃N₃Cl₂)_{z}] and Be[Ni(C₃O₃N₃Cl₂)₄], Naₓ[Ni_{y}(C₃O₃N₃Cl₂)_{z}] and Mg[Ni(C₃O₃N₃Cl₂)₄], Kₓ[Ni_{y}(C₃O₃N₃Cl₂)_{z}] and Mg[Ni(C₃O₃N₃Cl₂)₄], Liₓ[Ni_{y}(C₃O₃N₃Cl₂)_{z}] and Mg[Ni(C₃O₃N₃Cl₂)₄], Rbₓ[Ni_{y}(C₃O₃N₃Cl₂)_{z}] Rbₓ[Ni_{y}(C₃O₃N₃Cl₂)_{z}] and Mg[Ni(C₃O₃N₃Cl₂)₄], Csₓ[Ni_{y}(C₃O₃N₃Cl₂)_{z}] and Mg[Ni(C₃O₃N₃Cl₂)₄], Naₓ[Ni_{y}(C₃O₃N₃Cl₂)_{z}] and Sr[Ni(C₃O₃N₃Cl₂)₄], Kₓ[Ni_{y}(C₃O₃N₃Cl₂)_{z}] and Sr[Ni(C₃O₃N₃Cl₂)₄], Liₓ[Ni_{y}(C₃O₃N₃Cl₂)_{z}] and Sr[Ni(C₃O₃N₃Cl₂)₄], Rbₓ[Ni_{y}(C₃O₃N₃Cl₂)_{z}] and Sr[Ni(C₃O₃N₃Cl₂)₄] or Csₓ[Ni_{y}(C₃O₃N₃Cl₂)_{z}] and Sr[Ni(C₃O₃N₃Cl₂)₄] where x, y, and z in the above formulas are each independently 1 to 6.

In another aspect, the metal complexed cyanurate can be a mixture of Naₓ[Ni_{y}(C₃O₃N₃Cl₂)_{z}] and Ni(C₃O₃N₃Cl₂)₄²⁻, Liₓ[Ni_{y}(C₃O₃N₃Cl₂)_{z}] and Ni(C₃O₃N₃Cl₂)₄², Rbₓ[Ni_{y}(C₃O₃N₃Cl₂)_{z}] and Ni(C₃O₃N₃Cl₂)₄²⁻, Csₓ[Ni_{y}(C₃O₃N₃Cl₂)_{z}] and Ni(C₃O₃N₃Cl₂)₄², Kₓ[Ni_{y}(C₃O₃N₃Cl₂)_{z}] and Ni(C₃O₃N₃Cl₂)₄²⁻, Ba[Ni(C₃O₃N₃Cl₂)₄] and Ni(C₃O₃N₃Cl₂)₄², Ca[Ni(C₃O₃N₃Cl₂)₄] and Ni(C₃O₃N₃Cl₂)₄²⁻, Be[Ni(C₃O₃N₃Cl₂)₄] and Ni(C₃O₃N₃Cl₂)₄², Mg[Ni(C₃O₃N₃Cl₂)₄] and Ni(C₃O₃N₃Cl₂)₄²—, and Sr[Ni(C₃O₃N₃Cl₂)₄] and Ni(C₃O₃N₃Cl₂)₄²⁻, where x, y, and z in the above formulas are each independently 1 to 6.

In one aspect of the present disclosure, a non-limiting example of the metal complex is when M is Cd. The Cd complexed cyanurate composition can have the formula Aₓ[Cd_{y}(C₃O₃N₃Cl₂)_{z}], where x, y, and z are independently 1 to 6, Cd(C₃O₃N₃Cl₂)₄²—, or a mixture thereof, where A is an alkali metal, an alkaline earth metal, Al, or a combination thereof. The Cd metal complexed cyanurate composition can have the formula Aₓ[Cd_{y}(C₃O₃N₃Cl₂)_{z}], where x, y, and z are independently 1 to 6, Cd(C₃O₃N₃Cl₂)₄², or a mixture thereof, where A is an alkali metal, an alkaline earth metal, Al, or a combination thereof. Non-limiting examples of the metal complexed cyanurate with an alkali metal counterion can include Naₓ[Cd_{y}(C₃O₃N₃Cl₂)_{z}], Kₓ[Cd_{y}(C₃O₃N₃Cl₂)_{z}], Liₓ[Cd_{y}(C₃O₃N₃Cl₂)_{z}], Rbₓ[Cd_{y}(C₃O₃N₃Cl₂)_{z}], or Csₓ[Cd_{y}(C₃O₃N₃Cl₂)_{z}] where x, y and z are independently 1 to 6. Non-limiting examples of the metal complexed cyanurate with an alkaline earth metal counterion can include Ca[Cd(C₃O₃N₃Cl₂)₄], Ba[Cd(C₃O₃N₃Cl₂)₄], Be[Cd(C₃O₃N₃Cl₂)₄], Mg[Cd(C₃O₃N₃Cl₂)₄], or Sr[Cd(C₃O₃N₃Cl₂)₄]. Non-limiting examples of Cd complexed cyanurates with Al can include Alₓ[Cd_{y}(C₃O₃N₃Cl₂)_{z}] alone or in combination with the described Cd complexed cyanurates. Non-limiting examples of mixtures of the metal complexed cyanurate can include Naₓ[Cd_{y}(C₃O₃N₃Cl₂)_{z}] and Ca[Cd(C₃O₃N₃Cl₂)₄], Kₓ[Cd_{y}(C₃O₃N₃Cl₂)_{z}] and Ca[Cd(C₃O₃N₃Cl₂)₄], Liₓ[Cd_{y}(C₃O₃N₃Cl₂)_{z}] and Ca[Cd(C₃O₃N₃Cl₂)₄], Rbₓ[Cd_{y}(C₃O₃N₃Cl₂)_{z}] and Ca[Cd(C₃O₃N₃Cl₂)₄], Csₓ[Cd_{y}(C₃O₃N₃Cl₂)_{z}] and Ca[Cd(C₃O₃N₃Cl₂)₄], Naₓ[Cd_{y}(C₃O₃N₃Cl₂)_{z}] and Ba[Cd(C₃O₃N₃Cl₂)₄], Liₓ[Cd_{y}(C₃O₃N₃Cl₂)_{z}] and Ba[Cd(C₃O₃N₃Cl₂)₄], Kₓ[Cd_{y}(C₃O₃N₃Cl₂)_{z}] and Ba[Cd(C₃O₃N₃Cl₂)₄], Rbₓ[Cd_{y}(C₃O₃N₃Cl₂)_{z}] and Ba[Cd(C₃O₃N₃Cl₂)₄], Csₓ[Cd_{y}(C₃O₃N₃Cl₂)_{z}] and Ba[Cd(C₃O₃N₃Cl₂)₄], Naₓ[Cd_{y}(C₃O₃N₃Cl₂)_{z}] and Be[Cd(C₃O₃N₃Cl₂)₄], Kₓ[Cd_{y}(C₃O₃N₃Cl₂)_{z}] and Be[Cd(C₃O₃N₃Cl₂)₄], Liₓ[Cd_{y}(C₃O₃N₃Cl₂)_{z}] and Be[Cd(C₃O₃N₃Cl₂)₄], Rbₓ[Cd_{y}(C₃O₃N₃Cl₂)_{z}] and Be[Cd(C₃O₃N₃Cl₂)₄], Csₓ[Cd_{y}(C₃O₃N₃Cl₂)_{z}] and Be[Cd(C₃O₃N₃Cl₂)₄], Naₓ[Cd_{y}(C₃O₃N₃Cl₂)_{z}] and Mg[Cd(C₃O₃N₃Cl₂)₄], Kₓ[Cd_{y}(C₃O₃N₃Cl₂)_{z}] and Mg[Cd(C₃O₃N₃Cl₂)₄], Liₓ[Cd_{y}(C₃O₃N₃Cl₂)_{z}] and Mg[Cd(C₃O₃N₃Cl₂)₄], Rbₓ[Cd_{y}(C₃O₃N₃Cl₂)_{z}]Rbₓ[Cd_{y}(C₃O₃N₃Cl₂)_{z}] and Mg[Cd(C₃O₃N₃Cl₂)₄], Csₓ[Cd_{y}(C₃O₃N₃Cl₂)_{z}] and Mg[Cd(C₃O₃N₃Cl₂)₄], Naₓ[Cd_{y}(C₃O₃N₃Cl₂)_{z}] and Sr[Cd(C₃O₃N₃Cl₂)₄], Kₓ[Cd_{y}(C₃O₃N₃Cl₂)_{z}] and Sr[Cd(C₃O₃N₃Cl₂)₄], Liₓ[Cd_{y}(C₃O₃N₃Cl₂)_{z}] and Sr[Cd(C₃O₃N₃Cl₂)₄], Rbₓ[Cd_{y}(C₃O₃N₃Cl₂)_{z}] and Sr[Cd(C₃O₃N₃Cl₂)₄] or Csₓ[Cd_{y}(C₃O₃N₃Cl₂)_{z}] and Sr[Cd(C₃O₃N₃Cl₂)₄] where x, y, and z in the above formulas are each independently 1 to 6.

In another aspect, the metal complexed cyanurate can be a mixture of Naₓ[Cd_{y}(C₃O₃N₃Cl₂)_{z}] and Cd(C₃O₃N₃Cl₂)₄²⁻, Liₓ[Cd_{y}(C₃O₃N₃Cl₂)_{z}] and Cd(C₃O₃N₃Cl₂)₄², Rbₓ[Cd_{y}(C₃O₃N₃Cl₂)_{z}] and Cd(C₃O₃N₃Cl₂)₄²⁻, Csₓ[Cd_{y}(C₃O₃N₃Cl₂)_{z}] and Cd(C₃O₃N₃Cl₂)₄², Kₓ[Cd_{y}(C₃O₃N₃Cl₂)_{z}] and Cd(C₃O₃N₃Cl₂)₄²⁻, Ba[Cd(C₃O₃N₃Cl₂)₄] and Cd(C₃O₃N₃Cl₂)₄², Ca[Cd(C₃O₃N₃Cl₂)₄] and Cd(C₃O₃N₃Cl₂)₄²⁻, Be[Cd(C₃O₃N₃Cl₂)₄] and Cd(C₃O₃N₃Cl₂)₄², Mg[Cd(C₃O₃N₃Cl₂)₄] and Cd(C₃O₃N₃Cl₂)₄²—, and Sr[Cd(C₃O₃N₃Cl₂)₄] and Cd(C₃O₃N₃Cl₂)₄² where x, y, and z in the above formulas are each independently 1 to 6. Taylor in this mixture

In one aspect of the present disclosure, another non-limiting example of the metal complex is when M is Ag. The Ag complexed cyanurate composition can have the formula Aₓ[Ag_{y}(C₃O₃N₃Cl₂)_{z}], where x, y, and z are independently 1 to 6, Ag(C₃O₃N₃Cl₂)₄³, or a mixture thereof, where A is an alkali metal, an alkaline earth metal, Al, or a combination thereof. Non-limiting examples of the metal complexed cyanurate with an alkali metal counterion can include Naₓ[Ag_{y}(C₃O₃N₃Cl₂)_{z}], Kₓ[Ag_{y}(C₃O₃N₃Cl₂)_{z}], Liₓ[Ag_{y}(C₃O₃N₃Cl₂)_{z}], Rbₓ[Ag_{y}(C₃O₃N₃Cl₂)_{z}], or Csₓ[Ag_{y}(C₃O₃N₃Cl₂)_{z}] where x, y and z are independently 1 to 6. Non-limiting examples of the metal complexed cyanurate with an alkaline earth metal counterion can include Ca[Ag₂(C₃O₃N₃Cl₂)₄], Ba[Ag(C₃O₃N₃Cl₂)₄], Be[Ag₂(C₃O₃N₃Cl₂)₄], Mg[Ag₂(C₃O₃N₃Cl₂)₄], or Sr[Ag₂(C₃O₃N₃Cl₂)₄]. Non-limiting examples of Ag complexed cyanurates with Al can include Alₓ[Ag_{y}(C₃O₃N₃Cl₂)_{z}] alone or in combination with the described Ag complexed cyanurates. Non-limiting examples of mixtures of the Ag complexed cyanurates can include Naₓ[Ag_{y}(C₃O₃N₃Cl₂)_{z}] and Ca[Ag₂(C₃O₃N₃Cl₂)₄], Kₓ[Ag_{y}(C₃O₃N₃Cl₂)_{z}] and Ca[Ag₂(C₃O₃N₃Cl₂)₄], Liₓ[Ag_{y}(C₃O₃N₃Cl₂)_{z}], and Ca[Ag₂(C₃O₃N₃Cl₂)₄], Rbₓ[Ag_{y}(C₃O₃N₃Cl₂)_{z}] and Ca[Ag₂(C₃O₃N₃Cl₂)₄], Csₓ[Ag_{y}(C₃O₃N₃Cl₂)_{z}] and Ca[Ag₂(C₃O₃N₃Cl₂)₄], Naₓ[Ag_{y}(C₃O₃N₃Cl₂)_{z}] and Ba[Ag₂(C₃O₃N₃Cl₂)₄], Liₓ[Ag_{y}(C₃O₃N₃Cl₂)_{z}] and Ba[Ag₂(C₃O₃N₃Cl₂)₄], Kₓ[Ag_{y}(C₃O₃N₃Cl₂)_{z}] and Ba[Ag₂(C₃O₃N₃Cl₂)₄], Rbₓ[Ag_{y}(C₃O₃N₃Cl₂)_{z}] and Ba[Ag₂(C₃O₃N₃Cl₂)₄], Csₓ[Ag_{y}(C₃O₃N₃Cl₂)_{z}] and Ba[Ag₂(C₃O₃N₃Cl₂)₄], Naₓ[Ag_{y}(C₃O₃N₃Cl₂)_{z}] and Be[Ag₂(C₃O₃N₃Cl₂)₄], Kₓ[Ag_{y}(C₃O₃N₃Cl₂)_{z}] and Be[Ag₂(C₃O₃N₃Cl₂)₄], Liₓ[Ag_{y}(C₃O₃N₃Cl₂)_{z}] and Be[Ag₂(C₃O₃N₃Cl₂)₄], Rbₓ[Ag_{y}(C₃O₃N₃Cl₂)_{z}] and Be[Ag₂(C₃O₃N₃Cl₂)₄], Csₓ[Ag_{y}(C₃O₃N₃Cl₂)_{z}] and Be[Ag₂(C₃O₃N₃Cl₂)₄], Naₓ[Ag_{y}(C₃O₃N₃Cl₂)_{z}] and Mg[Ag₂(C₃O₃N₃Cl₂)₄], Kₓ[Ag_{y}(C₃O₃N₃Cl₂)_{z}] and Mg[Ag₂(C₃O₃N₃Cl₂)₄], Liₓ[Ag_{y}(C₃O₃N₃Cl₂)_{z}] and Mg[Ag₂(C₃O₃N₃Cl₂)₄], Rbₓ[Ag_{y}(C₃O₃N₃Cl₂)_{z}] Rbₓ[Ag_{y}(C₃O₃N₃Cl₂)_{z}] and Mg[Ag₂(C₃O₃N₃Cl₂)₄], Csₓ[Ag_{y}(C₃O₃N₃Cl₂)_{z}] and Mg[Ag₂(C₃O₃N₃Cl₂)₄], Naₓ[Ag_{y}(C₃O₃N₃Cl₂)_{z}] and Sr[Ag₂(C₃O₃N₃Cl₂)₄], Kₓ[Ag_{y}(C₃O₃N₃Cl₂)_{z}] and Sr[Ag₂(C₃O₃N₃Cl₂)₄], Liₓ[Ag_{y}(C₃O₃N₃Cl₂)_{z}] and Sr[Ag(C₃O₃N₃Cl₂)₄], Rbₓ[Ag_{y}(C₃O₃N₃Cl₂)_{z}] and Sr[Ag₂(C₃O₃N₃Cl₂)₄] or Csₓ[Ag_{y}(C₃O₃N₃Cl₂)_{z}] and Sr[Ag₂(C₃O₃N₃Cl₂)₄] where x, y, and z in the above formulas are each independently 1 to 6.

In another aspect, the metal complexed cyanurate can be a mixture of Naₓ[Ag_{y}(C₃O₃N₃Cl₂)_{z}] and Ag₂(C₃O₃N₃Cl₂)₄³⁻, Liₓ[Ag_{y}(C₃O₃N₃Cl₂)_{z}] and Ag₂(C₃O₃N₃Cl₂)₄³⁻, Rbₓ[Ag_{y}(C₃O₃N₃Cl₂)_{z}] and Ag₂(C₃O₃N₃Cl₂)₄³⁻, Csₓ[Ag_{y}(C₃O₃N₃Cl₂)_{z}] and Ag₂(C₃O₃N₃Cl₂)₄³⁻, Kₓ[Ag_{y}(C₃O₃N₃Cl₂)_{z}] and Ag₂(C₃O₃N₃Cl₂)₄³⁻, Ba[Ag₂Ag₂(C₃O₃N₃Cl₂)₄] and Ag₂(C₃O₃N₃Cl₂)₄³⁻, Ca[Ag₂(C₃O₃N₃Cl₂)₄] and Ag₂(C₃O₃N₃Cl₂)₄³⁻, Be[Ag₂(C₃O₃N₃Cl₂)₄] and Ag₂(C₃O₃N₃Cl₂)₄³⁻, Mg[Ag₂(C₃O₃N₃Cl₂)₄] and Ag₂(C₃O₃N₃Cl₂)₄³—, and Sr[Ag₂(C₃O₃N₃Cl₂)₄] and Ag₂(C₃O₃N₃Cl₂)₄³⁻, where x, y, and z in the above formulas are each independently 1 to 6.

In one aspect of the present disclosure, another non-limiting example of the metal complex is when M is Fe. The Fe complexed cyanurate composition can have the formula Aₓ[Fe_{y}(C₃O₃N₃Cl₂)_{z}], where x, y, and z are independently 1 to 6, Fe(C₃O₃N₃Cl₂)₄²—, or a mixture thereof, where A is an alkali metal, an alkaline earth metal, Al, or a combination thereof. Non-limiting examples of the iron complexed cyanurate with an alkali metal counterion can include Naₓ[Fe_{y}(C₃O₃N₃Cl₂)_{z}], Kₓ[Fe_{y}(C₃O₃N₃Cl₂)_{z}], Liₓ[Fe_{y}(C₃O₃N₃Cl₂)_{z}], Rbₓ[Fe_{y}(C₃O₃N₃Cl₂)_{z}], or Csₓ[Fe_{y}(C₃O₃N₃Cl₂)_{z}] where x, y and z are independently 1 to 6. Non-limiting examples of the iron complexed cyanurate with an alkaline earth metal counterion can include Ca[Fe(C₃O₃N₃Cl₂)₄], Ba[Fe(C₃O₃N₃Cl₂)₄], Be[Fe(C₃O₃N₃Cl₂)₄], Mg[Fe(C₃O₃N₃Cl₂)₄], or Sr[Fe(C₃O₃N₃Cl₂)₄]. Non-limiting examples of iron complexed cyanurates with Al can include Alₓ[Fe_{y}(C₃O₃N₃Cl₂)_{z}] alone or in combination with the described iron complexed cyanurates. Non-limiting examples of mixtures of iron complexed cyanurates can include Naₓ[Fe_{y}(C₃O₃N₃Cl₂)_{z}] and Ca[Fe(C₃O₃N₃Cl₂)₄], Kₓ[Fe_{y}(C₃O₃N₃Cl₂)_{z}] and Ca[Fe₂(C₃O₃N₃Cl₂)₄], Liₓ[Fe_{y}(C₃O₃N₃Cl₂)_{z}], and Ca[Fe(C₃O₃N₃Cl₂)₄], Rbₓ[Fe_{y}(C₃O₃N₃Cl₂)_{z}] and Ca[Fe₂(C₃O₃N₃Cl₂)₄], Csₓ[Fe_{y}(C₃O₃N₃Cl₂)_{z}] and Ca[Fe(C₃O₃N₃Cl₂)₄], Naₓ[Fe_{y}(C₃O₃N₃Cl₂)_{z}] and Ba[Fe₂(C₃O₃N₃Cl₂)₄], Liₓ[Fe_{y}(C₃O₃N₃Cl₂)_{z}] and Ba[Fe(C₃O₃N₃Cl₂)₄], Kₓ[Fe_{y}(C₃O₃N₃Cl₂)_{z}] and Ba[Fe₂(C₃O₃N₃Cl₂)₄], Rbₓ[Fe_{y}(C₃O₃N₃Cl₂)_{z}] and Ba[Fe(C₃O₃N₃Cl₂)₄], Csₓ[Fe_{y}(C₃O₃N₃Cl₂)_{z}] and Ba[Fe₂(C₃O₃N₃Cl₂)₄], Naₓ[Fe_{y}(C₃O₃N₃Cl₂)_{z}] and Be[Fe(C₃O₃N₃Cl₂)₄], Kₓ[Fe_{y}(C₃O₃N₃Cl₂)_{z}] and Be[Fe₂(C₃O₃N₃Cl₂)₄], Liₓ[Fe_{y}(C₃O₃N₃Cl₂)_{z}] and Be[Fe(C₃O₃N₃Cl₂)₄], Rbₓ[Fe_{y}(C₃O₃N₃Cl₂)_{z}] and Be[Fe₂(C₃O₃N₃Cl₂)₄], Csₓ[Fe_{y}(C₃O₃N₃Cl₂)_{z}] and Be[Fe(C₃O₃N₃Cl₂)₄], Naₓ[Fe_{y}(C₃O₃N₃Cl₂)_{z}] and Mg[Fe₂(C₃O₃N₃Cl₂)₄], Kₓ[Fe_{y}(C₃O₃N₃Cl₂)_{z}] and Mg[Fe(C₃O₃N₃Cl₂)₄], Liₓ[Fe_{y}(C₃O₃N₃Cl₂)_{z}] and Mg[Fe₂(C₃O₃N₃Cl₂)₄], Rbₓ[Fe_{y}(C₃O₃N₃Cl₂)_{z}] Rbₓ[Fe_{y}(C₃O₃N₃Cl₂)_{z}] and Mg[Fe₂(C₃O₃N₃Cl₂)₄], Csₓ[Fe_{y}(C₃O₃N₃Cl₂)_{z}] and Mg[Fe₂(C₃O₃N₃Cl₂)₄], Naₓ[Fe_{y}(C₃O₃N₃Cl₂)_{z}] and Sr[Fe₂(C₃O₃N₃Cl₂)₄], Kₓ[Fe_{y}(C₃O₃N₃Cl₂)_{z}] and Sr[Fe₂(C₃O₃N₃Cl₂)₄], Liₓ[Fe_{y}(C₃O₃N₃Cl₂)_{z}] and Sr[Fe₂(C₃O₃N₃Cl₂)₄], Rbₓ[Fe_{y}(C₃O₃N₃Cl₂)_{z}] and Sr[Fe₂(C₃O₃N₃Cl₂)₄] or Csₓ[Fe_{y}(C₃O₃N₃Cl₂)_{z}] and Sr[Fe₂(C₃O₃N₃Cl₂)₄] where x, y, and z in the above formulas are each independently 1 to 6.

In another aspect, the metal complexed cyanurate can be a mixture of Naₓ[Fe_{y}(C₃O₃N₃Cl₂)_{z}] and Fe(C₃O₃N₃Cl₂)₄²⁻, Liₓ[Fe_{y}(C₃O₃N₃Cl₂)_{z}] and Fe₂(C₃O₃N₃Cl₂)₄, Rbₓ[Fe_{y}(C₃O₃N₃Cl₂)_{z}] and Fe(C₃O₃N₃Cl₂)₄²⁻, Csₓ[Fe_{y}(C₃O₃N₃Cl₂)_{z}] and Fe₂(C₃O₃N₃Cl₂)₄, Kₓ[Fe_{y}(C₃O₃N₃Cl₂)_{z}] and Fe(C₃O₃N₃Cl₂)₄²⁻, Ba[Fe(C₃O₃N₃Cl₂)₄] and Fe₂(C₃O₃N₃Cl₂)₄, Ca[Fe(C₃O₃N₃Cl₂)₄] and Fe(C₃O₃N₃Cl₂)₄²⁻, Be[Fe(C₃O₃N₃Cl₂)₄] and Fe₂(C₃O₃N₃Cl₂)₄, Mg[Fe(C₃O₃N₃Cl₂)₄] and Fe(C₃O₃N₃Cl₂)₄²—, and Sr[Fe₂(C₃O₃N₃Cl₂)₄] and Fe(C₃O₃N₃Cl₂)₄², where x, y, and z in the above formulas are each independently 1 to 6.

The polymeric composition can include 0.01 wt. %, 0.1 wt. %, 0.15 wt. %, 0.2 wt. %, 0.25 wt. %, 0.3 wt. %, 0.35 wt. %, 0.4 wt. %, 0.45 wt. %, 0.5 wt. %, 0.55 wt. %, 0.6 wt. %, 0.65 wt. %, 0.7 wt. %, 0.75 wt. %, 0.8 wt. %, 0.85 wt. %, 0.9 wt. %, 0.95 wt. % or any value or range there between of the germicidal additive. In a preferred aspect, the polymer composition includes 0.01 wt. % to 1 wt. % or 0.01 wt. %, 0.05 wt. %, 0.1 wt. %, 0.15 wt. %, 0.2 wt. %, 0.25 wt. %, 0.3 wt. %, 0.35 wt. %, 0.4 wt. %, 0.45 wt. %, 0.5 wt. %, 0.55 wt. %, 0.6 wt. %, 0.65 wt. %, 0.7 wt. %, 0.75 wt. %, 0.8 wt. %, 0.85 wt. %, 0.9 wt. %, 0.95 wt. %, 1 wt. % or any value or range there between of Na₂[Cu(C₃O₃N₃Cl₂)₄]. In some aspects, the composition can include more than 1 wt. % (e.g., 1, 2, 3, 4, 5, 6, 7, 8, 10, 15, 20, or more or any range or number therein).

The metal complexed cyanurate can be prepared by reacting a cyanurate precursor with a metal precursor such as, for example, metal chlorides or metal nitrates as shown in the following general reaction Schemes I for an alkali metal (A) and II using a metal (M) nitrate salt.

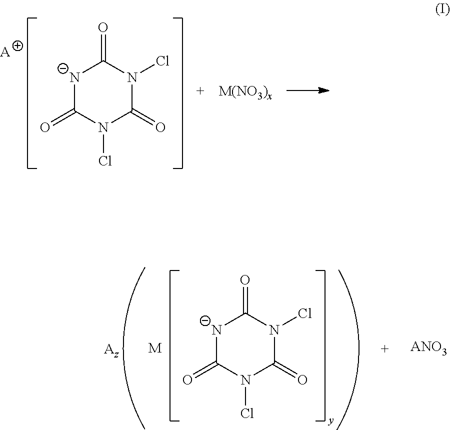

An aqueous solution of the metal precursor (e.g., copper nitrate) can be added slowly to an aqueous solution of the cyanurate precursor (sodium dichlorocyanurate) under agitation at room temperature (25° C. to 27° C.). The resulting precipitate can be filtered (e.g., gravity, centrifuged, vacuum and the like), collected and then dried in air at room temperature to produce the metal complexed cyanurate of the present disclosure.

### 2. Polymeric Matrix

The polymeric matrix of the present disclosure can include thermoplastic polymers, thermoset polymers, co-polymers thereof, or blends thereof. Amounts of the polymer matrix in the polymer composition can range from 35 wt. % to 99.99 wt. % or 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, 96 wt. %, 97 wt. %, 98 wt. %, 99 wt. %, 99.99 wt. % or any value or range there between. Thermoplastic polymeric matrices can become pliable or moldable above a specific temperature and solidify below the temperature. Non-limiting examples of thermoplastic polymers include polypropylene (PP), polyethylene (PE), polyethylene terephthalate (PET), polybutylene terephthalate (PBT), polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butyldiene styrene (ABS), poly(methyl methacrylate) (PMMA), blend of polycarbonate and polybutylene terephthalate (PBT), blend of polycarbonate-acrylonitrile butadiene styrene (ABS), blend of polyphenylene oxide and polystyrene, blend of polyphenylene oxide and polypropylene, elastomeric block co-polymers, blend of polycarbonate-polyethylene terephthalate (PET), polyamide, polystyrene (PS), glycol modified polycyclohexyl terephthalate (PCTG), poly(phenylene oxide) (PPO), poly(1,4-cyclohexylidene cyclohexane-1,4-dicarboxylate) (PCCD), poly(cyclohexanedimethylene terephthalate) (PCT), polyethylene naphthalate (PEN), polyamide (PA), engineered thermoplastic compositions, or blends or copolymers thereof. In addition to these, other thermoplastic polymers known to those of skill in the art, and those hereinafter developed, can also be used in the context of the present disclosure. In some aspects of the disclosure, the preferred thermoplastic polymers include polypropylene, polyamide, polyethylene terephthalate, a polycarbonate (PC) family of polymers, polybutylene terephthalate, poly(phenylene oxide) (PPO), polyetherimide, polyethylene, co-polymers thereof, or blends thereof. In more preferred aspects, the thermoplastic polymers include polyethylene, polypropylene, copolymers thereof, or blends thereof.

Thermoset polymers are polymers that cross-link or cure irreversibly. Thermoset polymers are malleable prior to heating and capable of forming a mold. The matrix can be made from a composition having a thermoplastic polymer and can also include other non-thermoplastic polymers, additives, and the like, that can be added to the composition. Thermoset polymeric matrices are cured or become cross-linked and tend to lose the ability to become pliable or moldable at raised temperatures. Non-limiting examples of thermoset polymers used to make the polymer film include epoxy resins, epoxy vinylesters, alkyds, amino-based polymers (e.g., polyurethanes, urea-formaldehyde), diallyl phthalate, phenolics polymers, polyesters, unsaturated polyester resins, dicyclopentadiene, polyimides, silicon polymers, cyanate esters of polycyanurates, thermosetting polyacrylic resins, bakelite, duroplast, benzoxazines, or co-polymers thereof, or blends thereof.

### 3. Other Additives

The polymeric composition of the present disclosure can include an additive or multiple additives. The polymeric composition can include a total of 0.0 wt. %, 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, or any value or range there between of one or more other additives.

Non-limiting examples of additives that can be used the polymer composition of the present disclosure can include anti-fogging agents, an antioxidant, a heat stabilizer, a hindered amine light stabilizer, a nucleating agent, a flow modifier, an UV absorber, an impact modifier, a coupling agent, a colorant, a processing aid, a reinforcing filler etc., or any combinations thereof. Reinforcing fillers can include short glass fibers, long glass fibers, talc, calcium carbonate, silica, or a combination thereof.

Coupling agents can include maleic anhydride grafted polyethylene, maleic anhydride grafted polypropylene, or a combination that includes at least one of the foregoing. Non-limiting examples of commercially available coupling agents include Polybond® 3150 maleic anhydride grafted polypropylene from Chemtura (U.S.A.), Fusabond® P613 maleic anhydride grafted polypropylene, from DuPont (U.S.A.), and Priex® 20097 maleic anhydride grafter polypropylene homopolymer from Addcomp (Germany). The polymeric matrix can include, based on the total weight of the polymeric matrix, 0.1 wt. % to 20 wt. % coupling agent or greater than or substantially equal to any one of, or between any two of 0.1 wt. %, 1 wt. %, 2 wt. %, 3.0 wt. %, 4 wt. %, 5.0 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, and 20 wt. % of coupling agent.

Non-limiting examples of antioxidants include sterically hindered phenolic compounds, aromatic amines, a phosphite compound, carbon black and the like. Non-limiting examples of phenolic antioxidants include 2,6-di-tert-butyl-4-methylphenol (CAS No. 128-37-0), pentaerythritol-tetrakis(3-(3,5-di-tert-butyl-4-hydroxyphenyl)propionate (CAS No. 6683-19-8), octadecyl 3-(3′,5′-di-tert-butyl-4-hydroxyphenyl)propionate (CAS No. 2082-79-3), 1,3,5-trimethyl-2,4,6-tris-(3,5-di-tert-butyl-4-hydroxybenzyl)benzene (CAS No. 1709-70-2), 2,2′-thiodiethylenebis(3,5-di-tert-butyl-4-hydroxyphenyl)propionate (CAS No. 41484-35-9), calcium bis(ethyl 3,5-di-tert-butyl-4-hydroxybenzylphosphonate) (CAS No. 65140-91-2), 1,3,5-tris(3′,5′-di-tert-butyl-4′-hydroxybenzyl)-isocyanurate (CAS No. 27676-62-6), 1,3,5-tris(4-tert-butyl-3-hydroxy-2,6-dimethylbenzyl)-1,3,5-triazine-2,4,6-(1H,3H,5H)-trione (CAS No. 40601-76-1), 3,3-bis(3-tert-butyl-4-hydroxyphenyl)ethylene butyrate (CAS No. 32509-66-3), 4,4′-thiobis(2-tert-butyl-5-methylphenol) (CAS No. 96-69-5), 2,2′-methylene-bis-(6-(1-methyl-cyclohexyl)-para-cresol) (CAS No. 77-62-3), 3,3′-bis(3,5-di-tert-butyl-4-hydroxyphenyl)-N,N′-hexamethylenedipropionamide (CAS No. 23128-74-7), 2,5,7,8-tetramethyl-2-(4′,8′,12′-trimethyltridecyl)-chroman-6-ol (CAS No. 10191-41-0), 2,2-ethylidenebis(4,6-di-tert-butylphenol) (CAS No. 35958-30-6), 1,1,3-tris(2-methyl-4-hydroxy-5′-tert-butylphenyl)butane (CAS No. 1843-03-4), 3,9-bis(1,1-dimethyl-2-(beta-(3-tert-butyl-4-hydroxy-5-methylphenyl)propionyloxy)ethyl)-2,4,8,10-tetraoxaspiro[5.5]undecane (CAS No. 90498-90-1;), 1,6-hexanediyl-bis(3,5-bis(1,1-dimethylethyl)-4-hydroxybenzene)propanoate) (CAS No. 35074-77-2), 2,6-di-tert-butyl-4-nonylphenol (CAS No. 4306-88-1), 4,4′-butylidenebis(6-tert-butyl-3-methylphenol (CAS No. 85-60-9); 2,2′-methylene bis(6-tert-butyl-4-methylphenol) (CAS No. 119-47-1), triethylenglycol-bis-(3-tert-butyl-4-hydroxy-5-methylphenyl)propionate (CAS No. 36443-68-2), a mixture of C₁₃ to C₁₅ linear and branched alkyl esters of 3-(3′,5′-di-tert-butyl-4′-hydroxyphenyl)propionic acid (CAS No. 171090-93-0), 2,2′-thiobis(6-tert-butyl-para-cresol) (CAS No. 90-66-4), diethyl-(3,5-di-tert-butyl-4-hydroxybenzyl)phosphate (CAS No. 976-56-7), 4,6-bis (octylthiomethyl)-ortho-cresol (CAS No. 110553-27-0), benzenepropanoic acid, octyl 3-(3,5-di-tert-butyl-4-hydroxyphenyl)propanoate (CAS No. 125643-61-0), 1,1,3-tris[2-methyl-4-[3-(3,5-di-tert-butyl-4-hydroxyphenyl)propionyloxy]-5-tert-butylphenyl]butane (CAS No. 180002-86-2), mixed styrenated phenols (CAS No. 61788-44-1), butylated, octylated phenols (CAS No. 68610-06-0), butylated reaction product of p-cresol and dicyclopentadiene (CAS No. 68610-51-5).

Non-limiting examples of phosphite antioxidant include one of tris(2,4-di-tert-butylphenyl)phosphite (CAS No. 31570-04-4), tris(2,4-di-tert-butylphenyl)phosphate (CAS No. 95906-11-9), bis(2,4-di-tert-butylphenyl)pentaerythritol diphosphite (CAS No. 26741-53-7); and tetrakis (2,4-di-butylphenyl)-4,4′-biphenylene diphosphonite (CAS No. 119345-01-6), and bis (2,4-dicumylphenyl)pentaerythritol diphosphite (CAS No. 154862-43-8).

Non-limiting examples of UV stabilizers include hindered amine light stabilizers, hydroxybenzophenones, hydroxyphenyl benzotriazoles, cyanoacrylates, oxanilides, hydroxyphenyl triazines, and combinations thereof. Non-limiting examples of hindered amine light stabilizers include dimethyl succinate polymer with 4-hydroxy-2,2,6,6-tetramethyl-1-piperidine ethanol (CAS No. 65447-77-0); poly[[6-((1,1,3,3-tetramethylbutyl)amino)-1,3,5-triazine2,4diyl][(2,2,6,6-tetramethyl-4-piperidyl)imino]hexamethylene[2,2,6,6-tetramethyl-4-piperidyl)imino]] (CAS No. 70624-18-9); and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane (CAS No. 106990-43-6).

Non-limiting examples of heat stabilizers include phenothiazine, p-methoxyphenol, cresol, benzhydrol, 2-methoxy-p-hydroquinone, 2,5-di-tert-butylquinone, diisopropylamine, and distearyl thiodipropionate (CAS No. 693-36-7). In a preferred embodiment, distearyl thiodipropionate which is sold under the trade name Irganox® PS 820 (BASF, Germany) is used.

Non-limiting examples of antioxidants include a mixture of at least two of 1,3,5-trimethyl-2,4,6-tris-(3,5-di-tert-butyl-4-hydroxybenzyl) benzene sold under the trade name of Irganox® 1330 (BASF, Germany), tris[2,4-bis(2-methyl-2-propanyl)phenyl] phosphite sold under the trade name of Irgafos® 168 (BASF, Germany), pentaerythritol-tetrakis (3-(3,5-di-tert-butyl-4-hydroxyphenyl) propionate sold under the trade name Irganox® 1010 (BASF, Germany), 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane sold under the trade name of Chimassorb 119 (BASF, Germany) is used.

Other examples of other additives can include stabilizers, UV absorbers, impact modifiers, and cross-linking agents. A non-limiting example of a stabilizer can include Irganox® B225, commercially available from BASF. Non-limiting examples of UV absorbers include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, or combinations thereof. Non-limiting examples of impact modifiers include elastomers/soft blocks dissolved in matrix-forming monomer(s), such as, for example, bulk HIPS, bulk ABS, reactor modified PP, Lomod, Lexan EXL, and/or the like, thermoplastic elastomers dispersed in matrix material by compounding, such as, for example, di-, tri-, and multiblock copolymers, (functionalized) olefin (co)polymers, and/or the like, pre-defined core-shell (substrate-graft) particles distributed in matrix material by compounding, such as, for example, MBS, ABS-HRG, AA, ASA-XTW, SWIM, and/or the like, or combinations thereof. Non-limiting examples of cross-linking agents include divinylbenzene, benzoyl peroxide, alkylenediol di(meth)acrylates, such as, for example, glycol bisacrylate and/or the like, alkylenetriol tri(meth)acrylates, polyester di(meth)acrylates, bisacrylamides, triallyl cyanurate, triallyl isocyanurate, allyl(meth)acrylate, diallyl maleate, diallyl fumarate, diallyl adipate, triallyl esters of citric acid, triallyl esters of phosphoric acid, or combinations thereof.

### B. Method of Preparing the Polymeric Composition

The polymeric composition can be made using know polymer producing methods. For example, a polymer matrix can be compounded (e.g., extruded, blended, kneaded, and the like) with the germicidal additive of the present disclosure and optional other additives to produce the polymeric composition of the present disclosure. Compounding can be done, for example, in air or under an inert atmosphere (e.g., nitrogen). During compounding, the polymer material can soften or melt, and the germicidal and optional additives are dispersed in the polymer matrix. Temperature of compounding can range from 150° C. to 320° C., or 175° C. to 275° C., 200° C. to 250° C., or 150° C., 160° C., 170° C., 180° C., 190° C., 200° C., 210° C., 220° C., 230° C., 240° C., 250° C., 260° C., 270° C., 280° C., 290° C., 300° C., 310° C., 320° C., or any value or range there between. The resulting polymer composition can be formed into an article. Non-limiting examples of forming include injection molding, extrusion, compression molding, rotational molding, blow molding, injection blow molding, 3-D printing, thermoforming, foaming, or casting.

### C. Article of Manufacture

The resulting formed article (e.g., an extrusion molded article, an injection molded article, a compression molded article, a rotational molded article, a blow molded article, an injection blow molded article, a 3-D printed article, a thermoformed article, a foamed article, or a cast film) can be a portion of an article of manufacture (e.g., a surface of an article of manufacture, a handle, an armrest, and the like) or is an article of manufacture. Non-limiting examples of articles of manufacture include an exterior and/or interior vehicle part, an exterior and/or interior train part, an exterior and/or interior airplane part, an exterior and/or interior building part, an electrical device part, an electronic device part, an industrial device part, packaging material, medical packing film and/or component, a medical tray, a blister pack, a medical component container, a food packing film, or a food container.

### EXAMPLES

The present disclosure will be described in greater detail by way of specific examples. The following examples are offered for illustrative purposes only and are not intended to limit the disclosure in any manner. Those of skill in the art will readily recognize a variety of noncritical parameters which can be changed or modified to yield essentially the same results.

### Example 1

### (Synthesis of Germicidal Additive, Copper Dichlorocyanurate)

A water solution of Cu(NO₃)₂ (10 g, 100 mL) was added dropwise to the water solution of sodium dichlorocyanurate (NaDCC, 10 g, 100 mL, Sigma Aldrich) under stirring. After 1 hour, the resulting precipitate was filtered and dried in air to produce the germicidal additive of the present disclosure, Na₂Cu(DCC)₄, as a purple colored solid in a quantitative yield.

### Example 2

### (Thermal Degradation Analysis of Germicidal Additive and Comparative Additive in Air and Nitrogen Atmosphere)

A thermal degradation study of the germicidal additive of the present disclosure (Example 1) and NaDCC (comparative additive) was performed using TGA (NETZSCH TG 209F1 Iris instrument) in environments of nitrogen and air at 10° C./min heating rate in a temperature range of 25 to 600° C. Around 15 mg of materials were used in the TGA analysis each time.

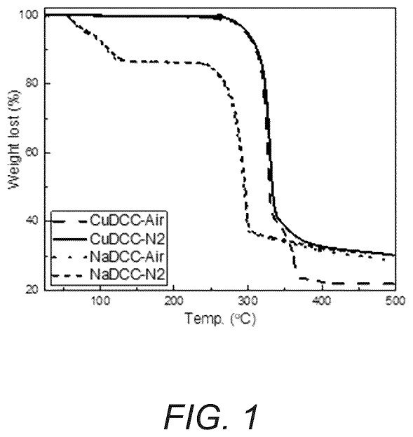

According to the shape of the thermographic (TG) curves and the number of derivatized thermographic (DTG) peaks in FIG. 1. The top two curves in FIG. 1 are the inventive germicidal additive in an air and a nitrogen atmosphere. The bottom two curves in FIG. 1 are NaDCC in an air atmosphere and NaDCC in a nitrogen atmosphere. Notably, the inventive germicidal additive showed high thermal stability up to 300° C. regardless of being in the presence of air or nitrogen. As evidenced by the sharp downward slope of the curve, oxidation or pyrolysis occurred from 300° C. to 340° C. in both air and nitrogen. In the presence of nitrogen (2^{nd} curve from the top of the graph) the curve at temperatures above 340° C. was attributed to carbonization of the inventive germicidal additive. The curve above 340° C., in the presence of air, was attributed to oxidation of the metal (e.g., Cu) to a metal oxide (e.g., CuO).

Referring to the bottom two curves, the thermal behavior of the comparative additive (NaDCC) at 50° C. to 500° C. was demonstratively different than the inventive germicidal additive. In the presence of both nitrogen and air, around 7% mass loss was observed between 55° C. to 100° C. This mass loss was attributed to the absorbed water. A further mass loss from 100° C. to 133° C. was due to was attributed to further loss of water. At 240° C. to 300° C. the most extensive mass loss (˜40%) was observed and was attributed to pyrolysis/oxidations of NaDCC. There was no apparent difference in the decomposition peak of the comparative NaDCC in the presence of air or nitrogen.

From the that the TG degradation analysis it was determined that the inventive germicidal additive was more stable than the comparative additive (NaDCC) regardless of the working atmosphere. Thus, it can be compounded with plastics and extruded at temperatures up to 340° C. Notably, the inventive germicidal additive was not hydroscopic based on the lack of mass loss between 55° C. to 133° C.

### Example 3

### (Preparation of the Polymer Composition of the Present Disclosure and Comparative Sample)

The germicidal additive of the present disclosure (Example 1) or NaDCC (comparative sample) was compounded with LLDPE. A lab-scale twin-screw compounder (Xplore—MC15) was used to mix the germicidal additive of Example 1 or comparative NaDCC into LLDPE 118NG. The process conditions were as follows:
Temperature: 180° C. under N₂
20 RPM feeding/exiting
50 RPM extrusion for 8 min
10 g of LLDPE 118NG powder (grinded) mixed with additive (Example 1, or NaDCC).
Purging with about 25 g raw LLDPE 118NG between runs.

### Example 4

### (Formed Article)

The composite of Example 3 was used to make a 15 cm×15 cm×0.1 cm sample by compression molding. A sheet/film was cast using performed using a HOT Platen Press (P 200 S Collin) with under pressure to produce the test specimens. Compression molding conditions was as following:
Sheet area=15×15 cm
Sheet thickness=2 mm
Temperature=190° C.
Heating time=5 min
Cooling time=5 min
Pressure=80 bar

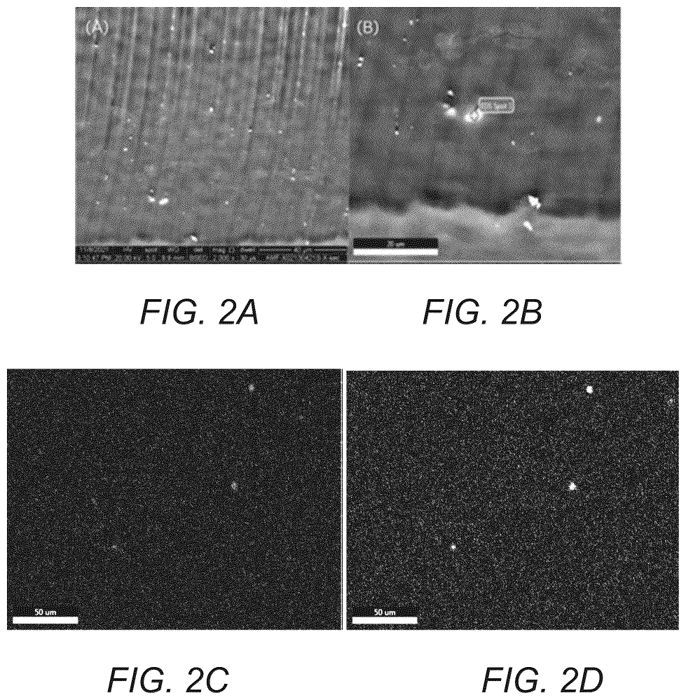

FIGS. 2A & 2B show the cross-section images of CuDCC-LLDPE polymer composition of the present disclosure. The particle size of the CuDCC of the present disclosure was between 1-5 um. The EDX mappings (FIGS. 2C, 2D, & 2E) indicated the uniform distribution of the CuDCC in the polymer matrix of the polymer composition of the present disclosure. Table 1 lists the elemental mapping.

TABLE 1

| Element | P1 | P2 | P3 |
|---|---|---|---|
| Carbon | 86.5 | 88.3 | 87.1 |
| Oxygen | 4.9 | 6.2 | 3.6 |
| Sodium | 1.7 | 0.7 | 2.0 |
| Aluminum | 0.1 | 0.1 | 0.1 |
| Chlorine | 4.4 | 2.4 | 4.5 |
| Copper | 2.4 | 2.3 | 2.7 |

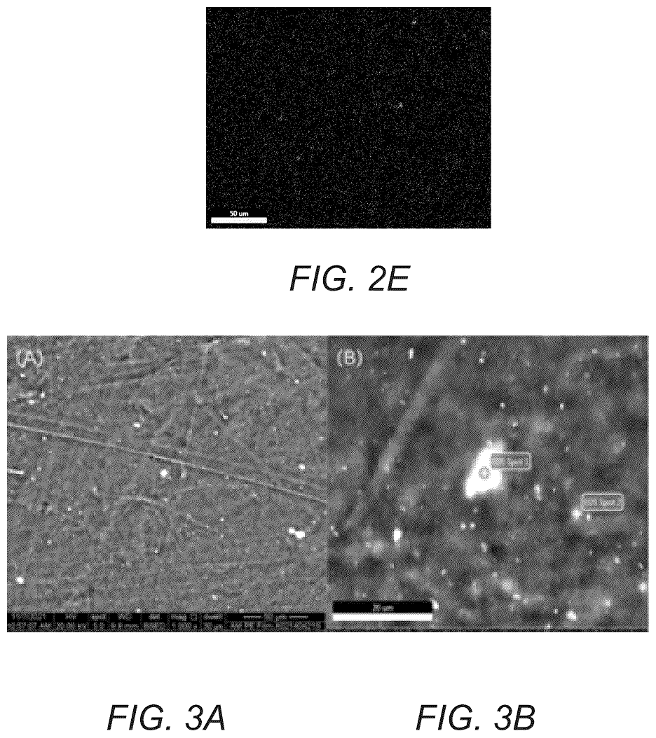

In the comparative sample, the NaDCC particle size distribution (1-15 um) was slightly larger than CuDCC in LLDPE (FIGS. 3A & 3B). The EDX mapping (FIGS. 3C, 3D, and 3F) showed apparent aggregation of the NaDCC. Table 2 lists the elemental mappings

TABLE 2

| Element | P1 | P2 | P3 | P4 |
|---|---|---|---|---|
| CK | 69.06 | 79.61 | 74.6 | 77.25 |
| NK | 2.52 | 8.01 | 5.98 | 4.29 |
| OK | 13.32 | 9.64 | 13.3 | 13.33 |
| NaK | 6.89 | 1.31 | 2.84 | 2.79 |
| AlK | 0.13 | 0.09 | 0.05 | 0.08 |
| SiK | 0.06 | 0.03 | 0.04 | 0.07 |
| ClK | 8.02 | 1.3 | 3.19 | 2.19 |

### Example 5

### (Antimicrobial Testing)

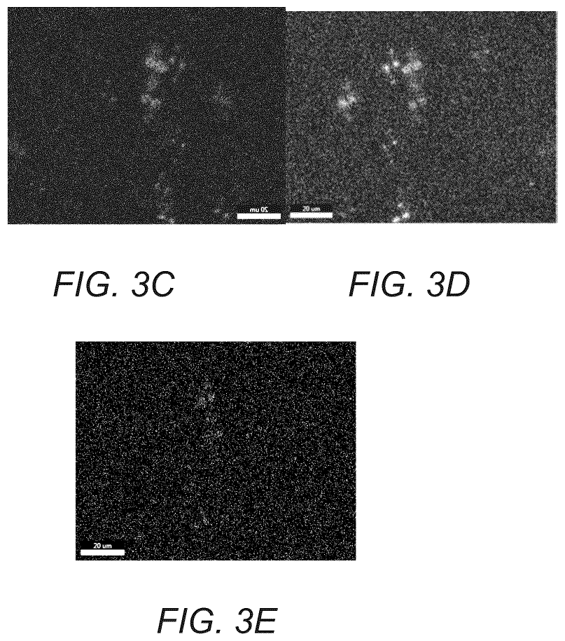

A standardized test organism (Staphylococcus aureus and Escherichia coli) was inoculated onto the surface of test materials of Example 3 (comparative sample and inventive sample). The standard specified an incubation period was 24 hours. Surviving microorganisms were counted to evaluate the antimicrobial activity of the test material. Counts were determined before and after incubation. Using a formula provided in the standard, the log of the difference between the 2 counts was determined to give a measurement of antimicrobial activity Eq.(1). FIG. 4 is a graphical illustration of the antibacterial results of a 0.2 wt. % CuDCC-LLDPE (inventive sample) and NaDCC-LLDPE (comparative sample). Both formulations showed high antibacterial activities at 0.2 wt. % in LLDPE, and both surfaces killed >99.99 of the bacteria after 24 hours.

$$R = log [ \# of bacteria untreated sample after 24 h ( B ) / \# of bacteria treated samples after 24 h ( C . ) ] \qquad Eq . ( 1 )$$

$$R = log ( B ) - log ( C )$$

$$R = Antibacterial activity ( \geq 2 )$$

### Example 6

### (Antiviral Testing)

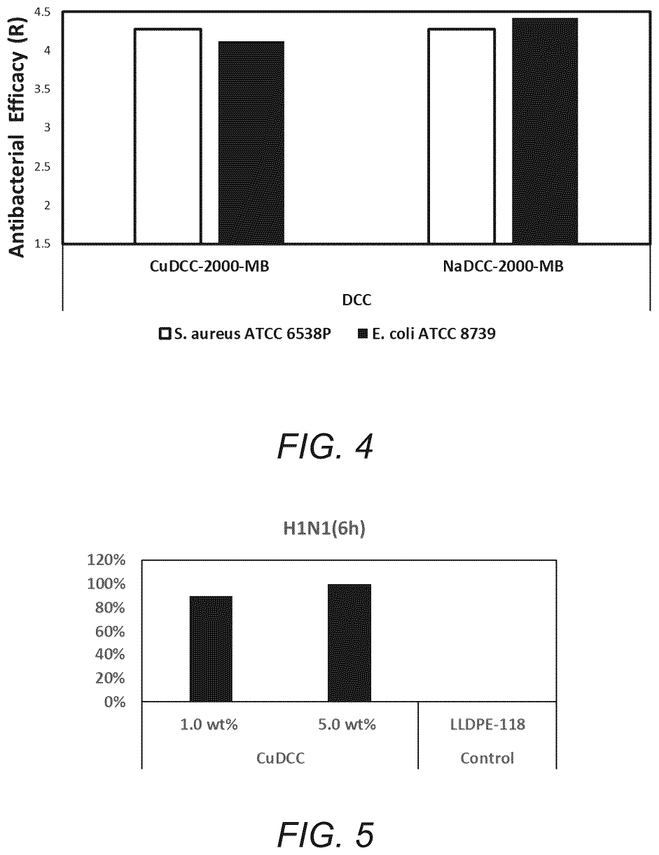

The IS021702 test method was used for the quantitative evaluation of virucidal activity on plastic materials. Other test methods can be used. Flat testing materials of Example 3 (inventive and comparative) were prepared according to the required dimension (5 cm×5 cm). The test materials were inoculated by laying Human Covid (Hcov-OC43) on the surface of the materials. The inoculated samples were incubated for 6 hours without drying the inoculum. Then, the inoculated virus was recovered, and the concentration of the infective virus was determined. The antiviral performance was determined by comparing the recovered virus from the untreated and treated material after 6 hours. at 0.5 wt. % and 5 wt. % loading of inventive germicidal additive (e.g., CuDCC) in the polymer matrix. Efficacy below 90% reduction was considered passing. Referring to FIG. 5, all samples but two showed passing results. The inventive test material showed 54% and 78.5% efficacy at 0.5 wt. % loading of the inventive germicidal additive and 99.85% efficacy 5.0 wt. % loading of the inventive germicidal additive. Two samples, one inventive and one comparative at 5 wt. % loading showed no effect.

### Example 7

### (Leaching Testing)

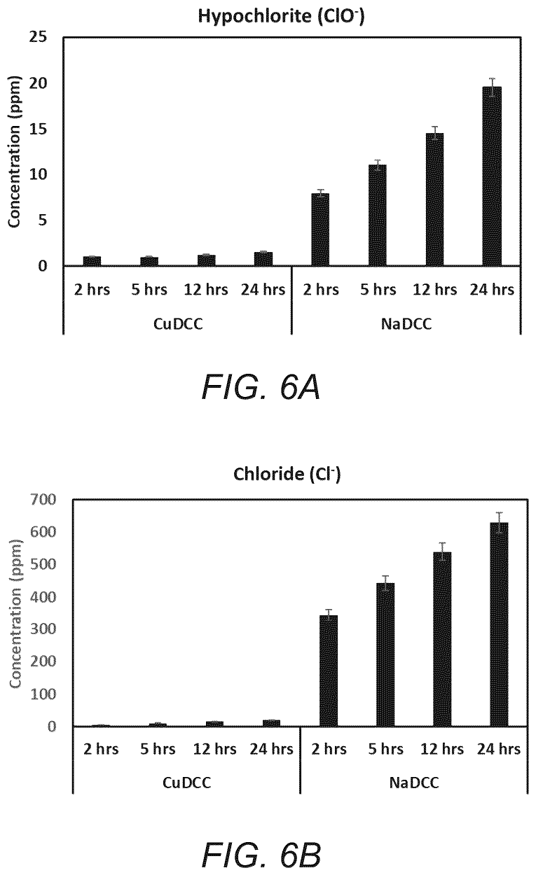

The inventive and comparative samples of Example 3 were subjected to a leaching test. Each sample (2 g, 10 wt. %) was placed in 40 mL water for 24 hours. The leaching results (FIGS. 6A and 6B) indicated that the 10 wt. % CuDCC/LLDPE-118 of the present disclosure showed much lower hypochlorite (FIG. 6A, ClO⁻, less than 5 ppm after 24 hours) and Cl content (FIG. 6B, less 5 ppm after 24 hours) in the mixture as compared to that of 10 wt. % the comparative sample, NaDCC/LLDPE-118 (greater than 15 ppm ClO⁻ after 24 hours and greater than 600 ppm after 24 hours) under the same condition. Thus, it was determined that the germicidal additive in a polymeric material indicating released the hypochlorite at much slower rate as compared to NaDCC-LLDPE. Moreover, the inventive test material did not have a chlorine smell.

### Example 8

### (Anti-Mold Testing)

The inventive samples of Example 3 were subjected to an anti-mold test according to ASTM G21-2015. The materials and texting procedure are as follows.

Culture Preparation. The fungi culture was streaked on potato dextrose agar and incubated for 7 to 20 days. A spore suspension of the fungi was prepared by using a sterile solution containing a wetting agent. A nichrome wire was used to gently scrape the surface growth from the culture of test organisms.

Preparation of Spore Suspension: The fungi spore suspension was poured into a sterile flask containing 45 mL of sterile water with wetting agent and 10 to 15 glass beads. The flask was capped and agitated. The suspension was filtered through sterile glass wool in a glass funnel into a sterile flask. The filtered spore suspension was centrifuged aseptically. The obtained supernatant liquid was suspended in sterile water and centrifuge again. The resulting liquid was diluted with nutrient salt medium to obtain a spore suspension of 1,000,000±200,000 spores/ml.

Procedure: Inventive test specimen materials (50 mm×50 mm) having 5 wt. % loading of the germicidal additive of the present disclosure (5 wt. % CuDCC/LLDPE-118) and a control sample of LLDPE-118 were placed on Nutrient salt agar. The tests were performed in triplicate. The spore suspension was sprayed on the specimen. Adequate positive and negative controls were also included along with the specimen. Table 3 lists the anti-mold experimental conditions. Table 4 lists the test organisms and spore count. Table 5 lists visual effects, and Table 6 lists a summary of the results. Observations were made weekly for the appearance of the density of fungal growth. The filter paper control pieces had copious fungal growth at 2 weeks. In 4th week, samples were rated “0” to “4” when examined microscopically to confirm the Ratings. The inventive test material having a 5.0 wt. % of the germicidal additive of the present disclosure showed a trace of fungal growth (<10%) while the control (LLDPE-118) had a complete growth at the end of 28 days of incubation when assessed as per method (ASTM: G 21) using Aspergillus Niger.

TABLE 3
The anti-mold experimental condition.

| | | | | | Dura- | Inoculum |
|---|---|---|---|---|---|---|
| | Positive | | Temp. | Humidity | tion | concentration |
| Method | control | Media | (° C.) | (%) | (day) | (spores/ml) |
| ASTM: | Sterile | Nutrient | 29 ± | 85 | 28 | 1,000,000 ± |
| G21 - | filter | salt agar | 1 | | | 200,000 |
| 2015 | paper | | | | | |

TABLE 4
Test organisms and spore count.

| | | Total Spores | Spores per ml of |
|---|---|---|---|
| | Count the | counted in | suspension (average |
| | number | the four | spore count per large |
| Organisms | of Spores | corner squares | square × 104) Spores/ml |
| Aspergillus | 98, 118, | 422 | 1.06 × 10⁶ |
| Niger | 105, 101 | | |
| ATCC 9642 | | | |

TABLE 5
Observation for visible effects.

| Growth on specimen | Rating |
|---|---|
| None | 0 |
| Trace of Growth (<10%) | 1 |
| Light Growth (10 to 30%) | 2 |
| Medium Growth (30 to 60%) | 3 |
| Heavy Growth (60% to complete coverage) | 4 |

TABLE 6
Anti-mold results of CuDCC/LLDPE-118.

| | Duration of the Test | | | |
|---|---|---|---|---|
| Sample | Week 1 | Week 2 | Week 3 | Week 4 |
| 5.0 wt. % CuDCC/LLDPE-118 | 0 | 0 | 0 | 1 |
| Color Control | 1 | 2 | 4 | 4 |

### Prophetic Example A

### (Synthesis of Germicidal Additive, Metal Complexed Dichlorocyanurate)

A water solution of metal (M) nitrate precursor ((e.g., nickel (II) nitrate, cadmium nitrate, silver nitrate, iron nitrate, or lithium nitrate,) 10 g, 100 mL) was added dropwise to the water solution of sodium dichlorocyanurate (NaDCC, 10 g, 100 mL, Sigma Aldrich) under stirring. After 1 hour, the resulting precipitate was filtered and dried in air to produce the germicidal additive of the present disclosure, NaₓM_{y}(DCC)_{z}, where M is the metal.

### Prophetic Example B

### (Preparation of Other Polyolefin Polymer Compositions of the Present Disclosure)

The germicidal additives of the present disclosure (Example 1 and Prophetic Example A) will be compounded with the polyolefin polymers, for example, polyethylene, polypropylene, low density polyethylene (LDPE), high density polyethylene (HDPE), or blends thereof. The germicidal additive will be mixed with plastic powder or pellets using a powder mixer, then extruded to form a composite material. This composite material will then be molded into the desired film shape using a compression molding process. Non-limiting conditions are as follows:
Temperature: 150° C. to 320° C. under N₂
20 RPM feeding/exiting
50 RPM extrusion for 8 min
10 g of polymer powder (grinded) mixed with inventive germicidal additive prepared using the method of Example 1 or Na₂Cu(DCC)₄.
Purging with about 25 g raw polymer between runs.

### Prophetic Example C

### (Preparation of a Terephthalate Polymer Compositions of the Present Disclosure)

The germicidal additive of the present disclosure (Example 1 or Prophetic Example A) will be compounded with PET or BET. A lab-scale twin-screw compounder (Xplore—MC15) will be used to mix the germicidal additive of Example 1 or Prophetic Example A into the PET or BET using the conditions of Prophetic Example B.

### Prophetic Example D

### (Preparation of a Polycarbonate Polymer Compositions of the Present Disclosure)

The germicidal additive of the present disclosure (Example 1 or Prophetic Example A) will be compounded with a polycarbonate polymer, a blend of polycarbonate and polybutylene terephthalate (PBT), a blend of polycarbonate-acrylonitrile butadiene styrene (ABS), or a blend of polycarbonate-polyethylene terephthalate (PET) (collectively polycarbonate polymer) using the conditions of Prophetic Example B.

### Prophetic Example E

### (Preparation of a PEI Polymer Compositions of the Present Disclosure)

The germicidal additive of the present disclosure (Example 1 or Prophetic Example A) will be compounded with a PEI polymer using the conditions of Prophetic Example B.

### Prophetic Example F

### (Preparation of a Polyethyleneimine Polymer Compositions of the Present Disclosure)

The germicidal additive of the present disclosure (Example 1 or Prophetic Example A) will be compounded with a polyethyleneimine polymer using the conditions of Prophetic Example B.

### Prophetic Example G

### (Preparation of a SAN Polymer Compositions of the Present Disclosure)

The germicidal additive of the present disclosure (Example 1 or Prophetic Example A) will be compounded with a SAN polymer using the conditions of Prophetic Example B.

### Prophetic Example H

### (Preparation of a PVC Polymer Compositions of the Present Disclosure)

The germicidal additive of the present disclosure (Example 1 or Prophetic Example A) will be compounded with a PVC polymer using the conditions of Prophetic Example B.

### Prophetic Example I

### (Preparation of an Epoxy Polymer Compositions of the Present Disclosure)

The germicidal additive of the present disclosure (Example 1 or Prophetic Example A) will be compounded with an epoxy polymer using the conditions of Prophetic Example B.

### Prophetic Example J

### (Preparation of a Polyether Polymer Compositions of the Present Disclosure)

The germicidal additive of the present disclosure (Example 1 or Prophetic Example A) will be compounded with a polyether ether ketone (PEEK) polymer, a polyether ketone ketone (PEKK) polymer, a blend thereof using the conditions of Prophetic Example B.

### Prophetic Example K

### (Preparation of a PPO Polymer Composition of the Present Disclosure)

The germicidal additive of the present disclosure (Example 1 or Prophetic Example A) will be compounded with a polyphenylene oxide (PPO) polymer or a blend of PPO and polypropylene using the conditions of Prophetic Example B.

### Prophetic Example L

### (Preparation of a Thermoplastic Polymer Compositions of the Present Disclosure)

The germicidal additive of the present disclosure (Example 1 or Prophetic Example A) will be compounded with a thermoplastic elastomer, an engineered thermoplastic composition, or a blend thereof using the conditions of Prophetic Example B.

### Prophetic Example M

### (Preparation of a PMMA Polymer Composition of the Present Disclosure)

The germicidal additive of the present disclosure (Example 1 or Prophetic Example A) will be compounded with a PMMA polymer using the conditions of Prophetic Example B.

### Prophetic Example N

### (Preparation of an ABS Polymer Composition of the Present Disclosure)

The germicidal additive of the present disclosure (Example 1 or Prophetic Example A) will be compounded with an ABS polymer using the conditions of Prophetic Example B.

### Prophetic Example O

### (Preparation of a Polystyrene Polymer Composition of the Present Disclosure)

The germicidal additive of the present disclosure (Example 1 or Prophetic Example A) will be compounded with a polystyrene polymer or a blend of blend of polyphenylene oxide and polystyrene using the conditions of Prophetic Example B.

### Prophetic Example P

### (Preparation of a Polyamide Polymer Composition of the Present Disclosure)

The germicidal additive of the present disclosure (Example 1 or Prophetic Example A) will be compounded with a polyamide polymer using the conditions of Prophetic Example B.

### Prophetic Example Q

### (Testing of a Prophetic Examples A-P of the Present Disclosure)

The prophetic polymer compositions of Examples A-P will be formed into an article using the method of Example 4. The articles will be assessed using the test methods of Examples 5-9. It is expected that the text results for prophetic samples A-P will be similar or better than the text results for the polymer composition of Example 1 and the comparative polymer containing NaDCC.

In conclusion, a polymer composition using the inventive germicidal additive of the present disclosure was made. The polymer composition had more DCC content, dual active sites such as Cu and DCC, less odor, and slower release than the comparative sample containing the common disinfection agent, DCC. While both additives showed antibacterial and antiviral efficacies towards gram-negative (Escherichia coli) and gram-positive (S. aureus) bacteria at a low concentration (2000 ppm) after 24 hours of incubation, the polymer composition of the present disclosure containing the germicidal additive of the present disclosure showed a better stability and durability with the same efficacy as the comparative polymer composition containing NaDCC. Finally, the polymer composition of the present disclosure containing the germicidal additive of the present disclosure showed resistance to mold growth. While only LLDPE has been evaluated, it is expected that other polymers compositions listed in the specification and examples will exhibit the same stability, durability, and efficacy and the exemplified inventive polymer composition.

Although embodiments of the present application and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A polymeric composition comprising a polymer matrix and a germicidal additive dispersed in the polymer matrix, the germicidal additive comprising a metal complexed cyanurate composition having a general formula of Aₓ[M_{y}(C₃O₃N₃Cl₂)_{z}], where:
A is a counterion comprising an alkali metal, an alkaline earth metal, Al, or a combination thereof;
x, y, and z are each independently 1 to 6; and
M is a transition metal that is copper (Cu), nickel (Ni), cadmium (Cd), silver (Ag), iron (Fe), an alloy thereof, or a combination thereof.

2. The polymeric composition of claim 1, wherein M is Cu and the metal complexed cyanurate composition comprises Aₓ[Cu(C₃O₃N₃Cl₂)₄], Cu(C₃O₃N₃Cl₂)₄]²⁻, or a mixture thereof, where A is a counterion comprising an alkali metal, an alkaline earth metal, Al, or a combination thereof, and x is 1 to 6.

3. The polymeric composition of claim 1, wherein the polymer matrix comprises a thermoplastic polymer, a thermoset polymer, or a blend thereof.

4. The polymeric composition of claim 3, wherein the thermoplastic polymer comprises polypropylene (PP), polyethylene (PE), polyethylene terephthalate (PET), polybutylene terephthalate (PBT), polycarbonate (PC), polyetherimide (PEI), polyethyleneimine, styrene-acrylonitrile resin (SAN), polyvinyl chloride (PVC), epoxy polymers, polyether ether ketone (PEEK), poly(phenylene oxide) (PPO), polyether ketone ketone (PEKK), polysulfone sulfonate (PSS), polyphenylene sulfide (PPS), sulfonates of polysulfones, thermoplastic elastomer (TPE), terephthalic acid (TPA) elastomers, acrylonitrile butyldiene styrene (ABS), poly(methyl methacrylate) (PMMA), blend of polycarbonate and polybutylene terephthalate (PBT), blend of polycarbonate-acrylonitrile butadiene styrene (ABS), blend of polyphenylene oxide and polystyrene, blend of polyphenylene oxide and polypropylene, elastomeric block co-polymers, blend of polycarbonate-polyethylene terephthalate (PET), polyamide, polystyrene (PS), engineered thermoplastic compositions, or blends or copolymers thereof, preferably polyethylene, polypropylene, copolymers thereof, or blends thereof.

5. The polymeric composition of claim 1, wherein the polymeric composition contains at least 35 to 99.99 wt. % of the polymer matrix, 0.01 wt. % to 1 wt. % of the germicidal additive, and 0 to 65 wt. % of other additives, wherein the other additives comprise reinforcing fillers, antioxidants, heat stabilizers, nucleating agents, coupling agents and processing aids.

6. The polymeric composition of claim 1, wherein the germicidal additive is a particle having a mean particle size of 1 to 30 microns, 1 to 20 microns, or 1 to 10 microns.

7. The polymeric composition of claim 6, wherein the germicidal additive is effective against bacteria, viruses, protozoa, algae, and fungi, and wherein the germicidal additive has antibacterial efficacy of at least 80%, 90%, or 99% after 24 hours of incubation as measured by JISZ 2801:2010 method, wherein the bacteria comprise Staphylococcus aureus, Escherichia coli or a combination thereof.

8. The polymeric composition of claim 1, wherein the polymeric composition has a low or is absent of a chlorine odor after contact with water for 24 hours.

9. The polymeric composition of claim 1, wherein the polymeric composition is a pellet, a powder, or a molded part.

10. The polymeric composition of claim 1, wherein the polymeric composition is an extrusion molded article, an injection molded article, a compression molded article, a rotational molded article, a blow molded article, an injection blow molded article, a 3-D printed article, a thermoformed article, a foamed article, or a cast film.

11. An article of manufacture comprising the polymeric composition of claim 1.

12. The article of claim 11, wherein the polymeric composition is comprised in the article of manufacture, wherein the article of manufacture is an exterior and/or interior vehicle part, an exterior and/or interior train part, an exterior and/or interior airplane part, an exterior and/or interior building part, an electrical device part, an electronic device part, an industrial device part, a packing film, a medical packing film and/or component, a medical tray, a blister pack, a medical component container, a food packing film, or a food container, preferably a packing film, a medical packing film and/or component, a food packing film or a combination thereof.

13. A method of preparing the polymeric composition of claim 1, the method comprising compounding a germicidal additive comprising a metal complexed cyanurate composition, wherein the metal comprises a transition metal that is copper (Cu), nickel (Ni), cadmium (Cd), silver (Ag), an alloy thereof, or a combination thereof, with a polymer matrix at 150° C. to 300° C. to produce the polymeric composition of claim 1.

14. The method of claim 13, wherein the transition metal is copper.

15. The method of claim 13, wherein the metal complexed cyanurate composition is produced by reacting a metal precursor with an aqueous solution of a cyanurate composition, and wherein the cyanurate composition is sodium dichloroisocyanurate.

16. The polymeric composition of claim 1, wherein the polymeric composition contains at least 35 to 99.99 wt. % of the thermoplastic polymer matrix, 0.01 wt. % to 1 wt. % of Na₂[Cu(C₃O₃N₃Cl₂)₄], and 0 to 55 wt. % of other additives, wherein the other additives comprise reinforcing fillers, antioxidants, heat stabilizers, nucleating agents, coupling agents and processing aids.

17. The polymeric composition of claim 2, wherein the metal complexed cyanurate composition is Na₂[Cu(C₃O₃N₃Cl₂)₄].
